(19) United States
(12) Patent Application Publication
(10) Pub. No.: US 2026/0352680 A1
(43) Pub. Date: Nov. 5, 2026

(54) IOBHUNTER - AUTOMATED DISCOVERY AND ANALYSIS OF BENIGN INDICATORS FOR INTERNET DOMAINS

(71) Applicant: Palo Alto Networks, Inc., Santa Clara, CA (US)

(72) Inventors: Zhenhua Chen, Milpitas, CA (US); Daiping Liu, Santa Clara, CA (US); Shu Wang, San Jose, CA (US); Fan Fei, Pleasanton, CA (US)

(21) Appl. No.: 19/194,848

(22) Filed: Apr. 30, 2025

(51) Int. Cl. H04L 9/40; G06F 16/906; G06N 3/042

(52) U.S. Cl. CPC H04L 63/1425; G06F 16/906; G06N 3/042

(57) ABSTRACT

The present application discloses a method, system, and computer system for identifying false positive classifications based on an automated discovery of benign indicators. The method includes: (i) obtaining an indication of a website to be classified, (ii) obtaining search results for the website, (iii) obtaining classification evidence for the website and search results based at least in part on querying an LLM for the classification evidence, and (iv) providing a website classification based at least in part on classification evidence.

### BACKGROUND OF THE INVENTION

With the rapid expansion of internet-based resources and services, organizations and individuals rely more heavily than ever on cybersecurity measures capable of accurately distinguishing between legitimate and malicious websites. Conventional website classification methods have historically depended on manually curated lists of malicious domains, heuristic-based reputation scoring, or static signatures. Although these traditional approaches remain widely employed, these approaches exhibit significant limitations, including an inability to scale effectively with the internet's growth, delayed responses to rapidly evolving online threats, and high rates of false positives or negatives. Such inaccuracies can disrupt legitimate activities and create unnecessary security vulnerabilities.

### BRIEF DESCRIPTION OF THE DRAWINGS

Various embodiments of the invention are disclosed in the following detailed description and the accompanying drawings.

FIG. 1 is a block diagram of an environment for performing a website classification according to various embodiments.

FIG. 2 is a flow diagram of a method for performing a website classification according to various embodiments.

FIG. 3 is a flow diagram of a method for performing a website classification according to various embodiments.

FIG. 4 is an example of a prompt for training a machine learning model to perform a domain classification according to various embodiments.

FIG. 5 is an example of a prompt for requesting a machine learning model to extract classification evidence based on search results for a domain according to various embodiments.

FIG. 6 is an example of a prompt for determining a domain classification based on an analysis of source information and an analysis on classification evidence according to various embodiments.

FIGS. 7A and 7B are examples of source information that are analyzed in connection with determining a domain classification according to various embodiments.

FIGS. 8A and 8B are examples of classification evidence that are extracted based on search query results and analyzed in connection with determining a domain classification according to various embodiments.

FIG. 9 is an example of search results obtained in connection with determining a domain classification according to various embodiments.

FIGS. 10A-10F are examples of prompts used in connection with using a machine learning model to obtain a domain classification according to various embodiments.

FIG. 11 is a flow diagram of a method for obtaining a domain classification for a particular domain according to various embodiments.

FIG. 12 is a flow diagram of a method for obtaining search results for a domain according to various embodiments.

FIG. 13 is a flow diagram of a method for obtaining search results for a domain according to various embodiments.

FIG. 14 is a flow diagram of a method for obtaining classification evidence associated with search results for a particular domain according to various embodiments.

FIG. 15 is a flow diagram of a method for obtaining classification information based on an analysis of source information for classification evidence according to various embodiments.

FIG. 16 is a flow diagram of a method for obtaining classification information based on classification evidence obtained based at least in part on the search results for the particular domain according to various embodiments.

FIG. 17 is a flow diagram of a method for obtaining a website classification for a domain according to various embodiments.

FIG. 18 is a flow diagram of a method for using the website classification in connection with detecting an erroneous network traffic sample classification according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various embodiments provide a system, method, computer program and device for performing a website classification. The website classification can be performed in connection with detecting false positive maliciousness classifications obtained from a maliciousness detector. The method includes (i) obtaining an indication of a website to be classified, (ii) obtaining search results for the website, (iii) obtaining classification evidence for the website and search results based at least in part on querying an LLM for the classification evidence, and (iv) providing a website classification based at least in part on classification evidence.

Various embodiments provide a system, method, computer program and device for performing a website classification. The system is trained to perform website classification based at least in part on analyzing previous maliciousness classifications, such as false positive maliciousness classifications. The method includes (i) obtaining a set of search engine results associated with a set of false positive classification samples, (ii) collecting additional domain knowledge for the set of false positive classification samples, (iii) analyzing the set of search engine results and the additional domain knowledge to determine classification indicators, including querying a large language model (LLM) for classification evidence, and (iv) storing the classification evidence, wherein the classification is used to perform website classification for a set of target websites.

Traditional cybersecurity solutions for classifying websites as malicious or benign typically rely on manual, signature-based, or reputation-based detection mechanisms. In signature-based approaches, websites or domains are compared against manually curated databases or “blacklists,” which catalog previously identified malicious websites. While straightforward and efficient for known threats, such blacklists are inherently reactive, requiring frequent updates to remain effective. Consequently, these methods lag behind newly emerging malicious websites and often lead to false negatives by failing to detect recently established threats that have not yet been included in the database.

Reputation-based techniques assess websites based on predefined indicators or heuristic scoring methodologies, including factors such as domain age, domain registration history, IP address reputation, and known hosting patterns associated with malicious activity. These approaches aim to proactively detect potential threats by analyzing characteristics commonly correlated with malicious websites. Although useful, reputation-based detection frequently generates false positives because benign websites, particularly those recently created or hosted on shared infrastructure, can unintentionally match suspicious heuristics and become incorrectly classified as threats.

To mitigate these false classifications, conventional systems commonly employ manual review and analysis processes. Human security analysts typically investigate flagged domains or URLs to verify their actual intent. This manual intervention, while accurate, is costly, time-consuming, and difficult to scale, especially given the vast number of websites requiring continuous monitoring. Alternatively, some conventional solutions utilize basic automated systems with heuristic rules or scoring thresholds that attempt to revalidate suspicious classifications. However, these rules and thresholds often lack the contextual sophistication needed to significantly reduce false positives or negatives.

More advanced conventional solutions integrate automated threat-intelligence platforms that periodically refresh databases or lists based on shared intelligence feeds from cybersecurity communities. These systems often benefit from greater responsiveness to emerging threats compared to static blacklists but still struggle with classifying contextually ambiguous cases or newly emerging benign websites, frequently requiring manual review and intervention to address ambiguous or borderline cases.

Overall, existing conventional techniques (e.g., including blacklists, reputation heuristics, basic automation, and manual intervention) have significant limitations regarding scalability, adaptability, accuracy, and responsiveness. The conventional techniques remain vulnerable to generating false positives and false negatives due to their reliance on static or heuristic-driven approaches and the limited incorporation of nuanced contextual information. Various embodiments described herein seek to address these drawbacks by employing advanced LLM-driven analyses, integrating comprehensive contextual intelligence gathered from multiple online sources, and automating sophisticated evaluation workflows, thereby substantially enhancing accuracy in detecting false positives or negatives.

Furthermore, malicious actors continue to adapt their strategies to circumvent traditional detection methods. Malicious actors frequently leverage previously benign domains or temporarily legitimate websites to host malicious content, thereby complicating the reliability of legacy classification systems. This underscores the critical need for an improved website classification approach capable of rapidly and accurately differentiating benign websites from malicious or compromised ones.

Various embodiments provide a system and/or method that implements an advanced approach to website classification, particularly aimed at identifying and reducing false positives and false negatives generated by conventional maliciousness detectors. This system integrates data-driven analysis with artificial intelligence techniques, notably LLMs, to achieve more accurate and reliable classifications. Specifically, the system begins by obtaining target websites through various means, including reviewing outputs from maliciousness detectors, directly receiving domains of interest from users or clients, or automatically extracting URLs from intercepted communications.

In some embodiments, the system combines internet-wide contextual data collection, LLMs, machine learning, and structured analytical frameworks. In some implementations, the system is configured to proactively query one or multiple search engines for search results related to websites (e.g., the target domains) undergoing classification. By systematically gathering and interpreting this publicly accessible information, the system can gain valuable insights into how each target website is perceived, referenced, and utilized across the broader internet.

Once target websites (e.g., target domains) are identified, the system queries one or more search engines to obtain publicly available references to each site. Once relevant search results are identified, the system implements LLMs to iteratively retrieve the data for the search results (e.g., data from the website/source site for the search result(s)) and analyze the retrieved data to extract context-rich evidence (e.g., classification evidence) regarding each website's intended use and public reputation. Using LLM-driven analysis, the system extracts detailed contextual evidence from these search results, including website content, descriptions, URLs, and metadata. It then further enhances the analysis by leveraging Generative AI (GenAI) and Retrieval-Augmented Generation (RAG) to obtain supplemental information from authoritative or public intelligence sources. This iterative process enriches the overall dataset, providing a more comprehensive understanding of each website's online presence, context, and reputation.

According to various embodiments, the extracted evidence (e.g., the evidence collected from the search results for the target domain), together with an in-depth assessment of the credibility and reliability of the sources providing that evidence, informs a comprehensive evaluation process. By performing rigorous analysis of both evidence content and source credibility (e.g., using heuristic rules, specially trained machine learning models, and tailored LLMs, etc.) the system greatly enhances classification accuracy.

According to various embodiments, the system comprises/implements a source analyzer and an evidence analyzer in connection with determining a website classification for a target domain. The source analyzer evaluates the credibility, category, and reliability of each source website using LLM-assisted categorization, heuristic rules, and machine-learning-based techniques. Concurrently, the evidence analyzer conducts an in-depth assessment of the extracted evidence itself, examining URLs, domain information, IP addresses, content patterns, and third-party website usage context, again applying heuristics, machine-learning models, or specialized LLMs trained specifically for evidence evaluation.

In some embodiments, the system integrates outputs from both the source analyzer and the evidence analyzer using a result classifier. The result classifier may comprise an LLM (e.g., the same LLM used for evidence extraction, or a specialized LLM for integrating the outputs from the source analyzer and the evidence analyzer). The result classifier can thus synthesize all available contextual and credibility-related information to generate a definitive website classification. The resulting website classification may then be stored in a trusted classification database for future reference or immediately communicated back to inline maliciousness detectors (e.g., inline security entities), allowing real-time recharacterization of websites initially misclassified. By combining comprehensive contextual data with advanced AI-driven analytical methods, this system significantly reduces inaccuracies associated with conventional classification approaches, thereby enhancing cybersecurity effectiveness, reducing operational disruptions, and improving confidence in threat detection outcomes.

This system provides significant advantages compared to conventional website classification techniques, particularly those relying primarily on manual blacklists, reputation-based scoring, or basic heuristic rules. One major benefit is the substantial improvement in accuracy, specifically in reducing false positives and false negatives. By leveraging LLMs and sophisticated Generative AI-driven analysis, the system incorporates nuanced contextual understanding from across the internet, enabling more precise classifications that reflect real-world website behaviors and reputations rather than relying solely on static indicators or simplistic patterns.

Another benefit of the disclosed system is its adaptability to rapidly changing online threats. Traditional classification methods, such as static blacklists or basic heuristic approaches, are typically reactive, lagging behind emerging malicious websites or failing to recognize new legitimate websites. In contrast, this system dynamically queries multiple search engines and iteratively gathers fresh contextual evidence through RAG techniques. This ensures the classification remains current and responsive to emerging threats or newly established benign domains, effectively addressing the shortcomings associated with static or outdated data sources.

Moreover, the integration of automated, AI-driven analytical components significantly enhances scalability and efficiency. While conventional systems often rely heavily on manual verification, which is time-consuming, costly, and difficult to scale, this system automates comprehensive analyses of evidence and source credibility. By deploying specialized machine learning models and LLMs (e.g., specially trained LLMs), the system can efficiently handle high volumes of classifications with consistent accuracy, enabling security teams to allocate their resources more effectively and focus on strategic priorities rather than routine classification reviews.

The system also offers a greater depth of analysis compared to conventional approaches, combining multiple layers of evaluation, for example, ranging from contextual content analysis and source credibility assessment to heuristic rule application and advanced machine learning evaluations. This multi-dimensional analytical approach ensures a robust and comprehensive classification decision-making process, far superior to the simplified single-dimensional analyses common in conventional methods.

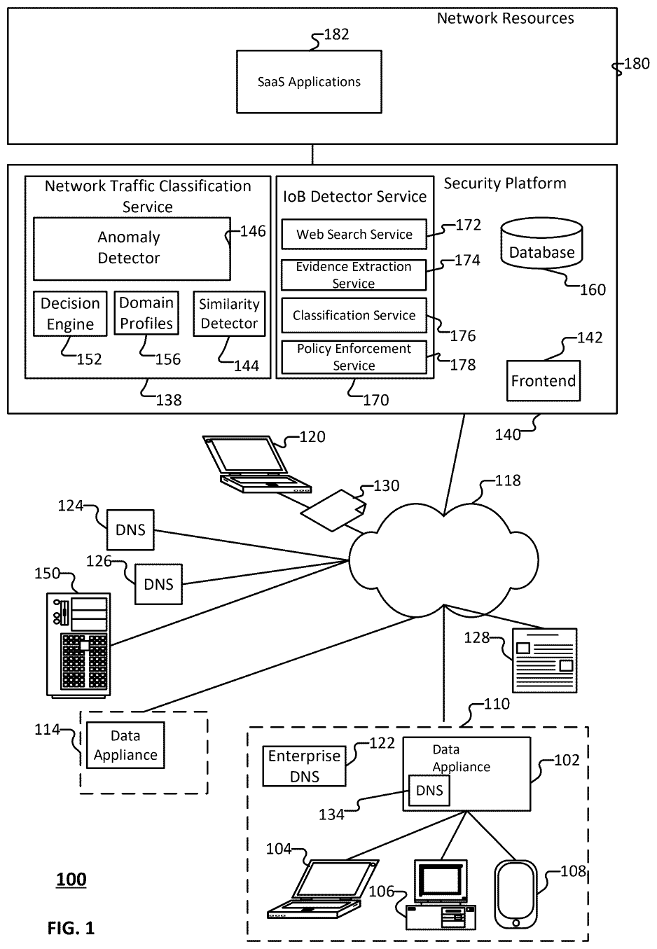

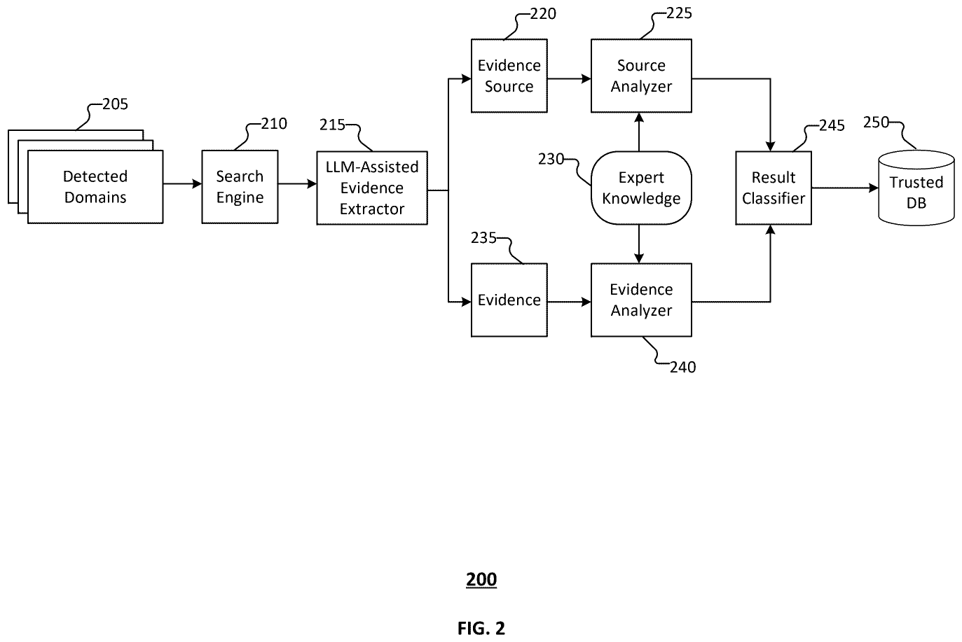

FIG. 1 is a block diagram of an environment for performing a website classification according to various embodiments. According to various embodiments, system 100 implements a security service that determines website classifications and/or detects false positive or false negatives from a maliciousness classifier (e.g., network traffic classification service 138). System 100 uses a machine learning model (e.g., LLM) to detect indicators of a benign website/domain (IoBs) and to classify a target website/domain. In some embodiments, system 100 implements at least part of one or more of processes 200-300 and 1100-1800 of FIGS. 2-3 and 11-18.

According to various embodiments, system 100 provides an advanced approach for classifying target domains (e.g., websites), especially focused on accurately distinguishing between benign and malicious sites in connection with detecting (and taking active measures with respect to) false positives or negatives from traditional maliciousness detectors. System 100 integrates automated search-based evidence collection, sophisticated contextual analysis, credibility assessments, and artificial intelligence techniques, including large language models (LLMs) and/or machine learning models, to achieve a precise and reliable website classification.

Initially, system 100 receives an indication of a target website (also referred to herein as a target domain) to classify. Target websites can originate from multiple sources, such as output from existing maliciousness detectors, direct submissions by cybersecurity clients, or URLs automatically extracted from intercepted communications (e.g., emails, text messages, or instant messages). For instance, when a maliciousness detector flags a website as malicious, the system can perform further analysis to confirm whether that initial classification was accurate or if it represented a false positive. In the example shown, IoB detector service 170 can receive target domains from network traffic classification service 138, which performs real-time and offline classifications of network traffic samples, or from an inline security entity that has performed an in-line classification (e.g., using a lightweight detector, etc.).

Upon identifying a target website, system 100 queries one or more search engines (e.g., such as Google, Bing, DuckDuckGo, or Yahoo) to retrieve relevant search results associated with that target website. The queries may simply include the target domain name or other identifying information. From these search results, system 100 gathers a representative set, either by collecting all returned results or by limiting the analysis to a predefined number of top-ranked results (e.g., the first 10, 25, 50, or 100 results), depending on configurable parameters which can be tailored to implementation requirements/demands.

System 100 then employs an LLM to analyze the obtained search results, extracting detailed evidence that informs subsequent classification steps. In some embodiments, system 100 causes the LLM to examine each search result's URL, snippet, and descriptive text, as well as contextual clues indicating how the target website is referenced or discussed. Additionally, system 100 may iteratively navigate to the actual web pages corresponding to these search results to gather supplemental evidence directly from their content. If certain sources are identified as repositories of public intelligence (e.g., such as known benign infrastructure lists or cybersecurity trust lists, etc.) the system leverages Generative AI (GenAI) and Retrieval-Augmented Generation (RAG) techniques to further extract related domains or context-rich supplemental information, expanding and enriching the dataset used for classification of the target domains.

Following evidence extraction, system 100 (e.g., classification service 176) analyzes the sources of the collected evidence through a dedicated component called the source analyzer. In some embodiments, the source analyzer evaluates each search result website's (e.g., the source site) trustworthiness, credibility, and reputation, leveraging heuristic or rule-based criteria, specialized machine learning models, or a specifically trained LLM. This analysis categorizes sources into predefined types (e.g., media outlets, professional directories, cybersecurity repositories, social media platforms) and assigns reliability scores or trust ratings accordingly, ensuring evidence is appropriately weighted based on source quality. Similarly, in some embodiments, in implementations where system 100 has retrieved supplemental information from supplemental sources (e.g., third party services, proprietary knowledge bases, etc.), system 100 uses the source analyzer to analyze the trustworthiness, credibility, and reputation of the sources for such supplemental information.

In parallel, an evidence analyzer independently examines the actual extracted evidence content, assessing critical characteristics like URL structures, domain registrations, IP reputation, textual context, and explicit references to malicious indicators or benign activity. This analysis, similarly supported by heuristic rules, specialized machine learning models, or trained LLMs, provides a nuanced interpretation of evidence indicative of either legitimate usage or potential malicious intent.

After these two analyses (e.g., the analysis of source information by the source analyzer and the analysis of classification evidence by the evidence analyzer) are completed, system 100 (e.g., classification service 176) synthesizes (e.g., integrates, combines, etc.) their outputs through an integrative classification step. In some embodiments, classification service 176 implements (e.g., invokes) an LLM (e.g., either the same as the LLM used to analyze search results and extract classification evidence or separately specialized) takes as input both the source analyzer and evidence analyzer outcomes, comprehensively evaluating and balancing the credibility of sources against the specific content and contextual indicators extracted. This LLM-driven synthesis enables highly accurate and context-aware decision-making, ultimately leading to the determination of the target website's classification as benign or malicious, which can thus be used to detect false positives or false negatives or otherwise in the enforcement of security policies (e.g., by policy enforcement service 178).

Finally, system 100 communicates the resulting classification (e.g., the website classification) or stores such resulting classification for further use, for example, by storing the website classification in database 160 (e.g., a mapping of target domains to website classifications, an allowlist, and/or a denylist). For example, system 100 may store the classification in a trusted database (e.g., database 160), allowing future reference or retrieval by cybersecurity services within an organization. Alternatively, the classification result may be directly communicated to inline maliciousness detection services that actively monitor and mediate network traffic, enabling real-time correction or verification of initial classifications and reducing disruptions caused by false positives or false negatives.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively blocking or sinkholing traffic, such as traffic to malicious domains, DNS hijacked domains, stockpiled domains, or squatting domains, or such as traffic for certain applications (e.g., SaaS applications). In some embodiments, data appliance 102 is also configured to enforce policies with respect to traffic that stays within (or from coming into) enterprise network 110.

System 100 comprises a security platform 140 that can provide security services for network resources 180 (e.g., a cloud infrastructure), such as software-as-a-service (SaaS) applications 182. For example, security platform 140 can perform authentication services for authentication of endpoints, such as client devices 104-108, in connection with providing access to network resources 180. As another example, security platform 140 can manage access policies, including dynamically provisioning access policies for ad hoc user access requests. As another example, security platform 140 can enforce security policies with respect to network traffic traversing an enterprise network such as by intercepting network traffic, classifying network traffic samples (e.g., by network traffic classification service 138 or an inline security entity) and causing applicable service policies to be enforced based on the network traffic sample classifications.

Techniques described herein can be used in conjunction with a variety of platforms (e.g., desktops, mobile devices, gaming platforms, embedded systems, etc.) and/or a variety of types of applications (e.g., Android . ask files, iOS applications, Windows PE files, Adobe Acrobat PDF files, Microsoft Windows PE installers, etc.). In the example environment shown in FIG. 1, client devices 104-108 are endpoints, such as a laptop computer, a desktop computer, and a tablet (respectively) present in an enterprise network 110. Client device 120 is a laptop computer present outside of enterprise network 110.

Data appliance 102 (e.g., a security entity) can be configured to work in cooperation with remote security platform 140. Security platform 140 can provide a variety of services, including authenticating endpoints, provisioning access policies for accessing network resources 180, providing secure access to network resources 180, auditing use of provisioned access policies, auditing access events to network resources 180, resolving DNS queries, providing DNS resolving security services, classifying domains (e.g., predicting whether a domain is a malicious domain, etc.), classifying websites (e.g., predicting whether a website is malicious or benign, etc.), classifying DNS response records (e.g., predicting whether a domain IP pair in a DNS response is a DNS hijacked record, etc.), classifying network traffic, classifying DNS traffic, providing a mapping of signatures to certain domains or DNS records, performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacked record, detecting squatting domains, detecting a DNS cache poisoning attack (e.g., an attempt or a DNS cache entry stored based on an effective DNS cache poisoning attack), providing a list of signatures of known exploits (e.g., malicious input strings, malicious files, malicious domains, etc.) to data appliances, such as data appliance 102 as part of a subscription, detecting exploits such as malicious input strings, malicious files, DNS hijacked records or malicious domains (e.g., an on-demand detection, or periodical-based updates to a mapping of domains or DNS records to indications of whether the domains or DNS records are malicious or benign), providing a likelihood that DNS traffic (e.g., a domain or DNS record comprised in the DNS traffic) is malicious or benign, providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign), etc.

In some embodiments, network security services, such as authentication services, are implemented at data appliance 102. As an example, data appliance 102 can authenticate endpoints for access to network resources 180. The authentication services may include performing IKEv2 authentication for the endpoints.

In some embodiments, network security services are implemented by one or more servers, such as a cloud service. Examples of the network security services implemented by security platform 140 (e.g., IoB detector service 170) include one or more of: (a) obtaining target domains (e.g., domains classified by network traffic classification service 138 or an inline security entity), (b) querying a search engine(s) to perform a web search based on the target domains, (c) retrieving/obtaining search results for the target domains, (d) analyzing the search results (e.g., the corresponding source sites) and categorize the applicable target domain, (e) extracting evidence (e.g., classification evidence) from the search results websites (e.g., the source site), (f) querying an LLM to extract the classification evidence from the search results websites for a particular target domain, (h) analyzing source information for the search result sources or the sources of supplemental information to identify maliciousness indicators or benign indicators or to otherwise determine/assess a source's trustworthiness, credibility, and reputation, (i) obtaining a representation of a source based on the outcome/output from the source analysis (e.g., obtain a feature vector representing the source), (j) analyzing the extracted evidence for a target domain to identify maliciousness indicators or benign indicators or to otherwise determine/assess identify anomalies, misrepresentations, or reputational clues indicative of potential maliciousness or benign intent, which may include analyzing URLs, domains, IP addresses, and hosting information, considering signals such as unusual domain naming conventions, questionable hosting providers, or correlations with known malicious infrastructure, (k) integrating the outputs from the source analysis and the evidence analysis to obtain a final classification outcome (e.g., a website classification), (l) querying an LLM to evaluate the outcomes from the source analysis and the evidence analysis for a target domain and to determine the classification for the target domain (e.g., determine whether the target domain is malicious or benign), (m) using the website classification to detect false positives or false negatives in detections performed by other inline, real time, or offline classifiers, (n) storing the website classification, for example, in a database such as in a mapping of target domains to website classifications, or in a list such as an allowlist or denylist, (o) causing one or more security policies to be enforced based on the website classification (e.g., pushing out updated allowlists or denylists to inline security entities, etc.).

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware Six, Citrix eServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

According to various embodiments, security platform 140 comprises/implements network traffic classification service 138 and/or IoB detector service 170. Security platform 140 may include various other services/modules, such as a malicious file detector, a malicious traffic detector, a parked domain detector, an application classifier or other traffic classifier, etc.

Network traffic classification service 138 is used in connection with analyzing network traffic (e.g., websites, domains, sample files, etc. pertaining to the network traffic) and/or automatically detecting malicious network traffic. For example, network traffic classification service may include anomaly detector 145, decision engine 152, domain profiles 156, and/or similarity detector 144.

IoB detector service 170 is used in connection with determining website classifications for target domains, for example, for use in detecting false positives or false negatives generated by other classifiers. IoB detector service 170 collects web results for the target domain and uses an LLM to analyze the search results (e.g., the corresponding source sites/webpages) and extract evidence from the search results sources. In response to extracting the evidence, IoB detector service 170 classifies the target domain based at least in part on the evidence. IoB detector service 170 may additionally classify the target domain based at least in part on source information pertaining to the search result sources. IoB detector service 170 determines a final classification outcome (e.g., a website classification) and uses this outcome in connection with enforcing security policies.

In some embodiments, IoB detector service 170 comprises one or more of web search service 172, evidence extraction service 174, classification service 176, and/or policy enforcement service 178,

IoB detector service 170 uses web search service 172 to obtain web search results for a set of predefined target domains, such as domains for which security platform 140 is to perform a website classification using IoB detector service 170 (e.g., target domains for which a false negative/false positive detection is to be performed). In some embodiments, web search service 172 queries one or more search engines based on a target domain and collects search results. For example, web search service 172 obtains a threshold number of search results such as a threshold number of highest/top ranked search results. As another example, web search service 172 obtains a threshold percentage of search results such as a threshold percentage of highest/top ranked search results (e.g., the top 10%, 25%, 50%, etc. ranked search results).

IoB detector service 170 uses evidence extraction service 174 to analyze the search results, for example, the websites corresponding to the search results (e.g., the source sites) and extracts evidence (e.g., the classification evidence) for these websites. The evidence may be extracted based on website metadata, website content, website/domain registration, etc. In some embodiments, evidence extraction service 174 queries an LLM to extract the evidence for the search results (e.g., from the source sites). The LLM may be a generic LLM such as Gemini, ChatGPT, Llama, Grok, etc. In other implementations, the LLM may be specifically configured/trained to extract evidence for website classification.

IoB detector service 170 uses classification service 176 to classify a target domain. Classification service 176 analyze the extracted evidence and/or source information for the extracted evidence (e.g., source information for the sources from which the evidence is extracted) and determines the website classification based at least in prat on the extracted evidence and the source information. In some embodiments, classification service 176 analyzes the extracted evidence by querying an evidence analyzer to analyze the evidence. The evidence analyzer may be a rule-based and/or heuristics-based analyzer that extracts information that may be indicative of whether the target domain is malicious or benign. The evidence analyzer may be comprised in classification service 176. In some embodiments, classification service 176 analyzes the source information for the search results sources by querying a source analyzer to analyze the source information. The source analyzer may be a rule-based and/or heuristics-based analyzer that extracts information that may be indicative of whether the target domain is malicious or benign, for example, information indicating a trustworthiness, a reputation, a usefulness, etc. of the source(s). The source analyzer may be comprised in classification service 176. In some embodiments, classification service 176 combines/integrates the outputs from the source analyzer and the evidence analyzer to determine a final classification outcome, for example, the website classification.

IoB detector service 170 uses policy enforcement service 178 to enforce one or more security policies. In some embodiments, policy enforcement service 178 causes one or more policies to be enforced with respect to the target domain based at least in part on the corresponding website classification determined by IoB detector service 170. In some implementations, causing a policy to be enforced includes storing the website classification in a mapping of target domains to website classifications, or updating an allowlist or denylist based on the website classification. In some implementations, causing a policy to be enforced includes providing an indication of the website classification to another system or service, such as an inline security entity that handles corresponding network traffic based on the website classification and the applicable security policy.

Network traffic classification service 138 may comprise an anomaly detector 146 (e.g., configured to detect anomalies in network traffic, file samples obtained by intercepting traffic, DNS traffic, or DNS records, etc.), a decision engine 152 (e.g., configured to predict whether network traffic, intercepted file samples, or whether a DNS record is malicious), domain profiles 156, and/or a similarity detector 144. In some embodiments, network traffic classification service 138 detects malicious network traffic or malware obtained from intercepted network traffic (e.g., by classifying a file sample obtained by a security entity or other network node requesting a maliciousness classification).

Network traffic classification service 138 can determine the classification for network traffic (e.g., a file sample obtained from network traffic, a DNS record, a DNS query, a DNS response, a website content, etc.) based at least in part on querying a classifier(s). The classifier that is queried to provide a classification of the network traffic sample associated with the network activity is a fingerprinting-based classifier, a heuristics-based classifier, another rule-based classifier, and/or a machine-learning based classifier. The classifier may be trained based at least in part on historical samples (e.g., samples of network traffic samples extracted from network traffic). The classifier can be trained based at least in part on a machine learning process.

The classifier(s) may implement one or more machine learning models that may be trained according to a machine learning process. Examples of machine learning processes that can be implemented include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc.

According to various embodiments, security platform 140 may receive a query from a security entity (e.g., inline firewall, such as a next generation firewall) for a real-time or offline classification of a network traffic sample, such as a file or a domains/website.

According to various embodiments, in response to network traffic classification service 138 classifying the network traffic sample, system 100 handles the corresponding network traffic according to a predefined policy (e.g., a security policy). For example, in response to predicting that the network traffic sample corresponds to malicious network traffic (e.g., that the domain associated with the network traffic is a squatting domain), system 100 can cause the network traffic to be blocked or quarantined, etc. As another example, system 100 can cause traffic to/from a compromised host (e.g., the client system associated with the intercepted network traffic from which the malicious domain was extracted) to be quarantined or sinkholed, etc. (e.g., at least until an administrator actively configures system 100 to proceed with permitting traffic to/from the client system, such as in response to the compromised host being remediated). In some embodiments, in response to network traffic classification service 138 classifying the network traffic sample, system 100 causes IoB detector service 170 to detect whether the classification is a false positive or false negative, and system 100 then handles the corresponding network traffic according to a predefined policy based at least in part on the network traffic sample classification obtained from network classification service 138 and the website classification obtained by IoB detector service 170.

According to various embodiments, in response to network traffic classification service 138 and/or IoB detector service 170 classifying the network traffic (e.g., the network traffic sample, or a domain associated with the network traffic sample), system 100 handles the network traffic according to a predefined policy (e.g., a security policy). For example, the system queries a traffic handling policy to determine the manner by which the network traffic (e.g., network activity for a session associated with the network traffic sample) is to be handled. The traffic handling policy may be a predefined policy, such as a security policy, etc. The traffic handling policy may indicate that network traffic associated with certain domains (e.g., domains classified as squatting domains) or having certain characteristics/profiles is to be blocked and network traffic associated with other domains (e.g., domains not deemed to be squatting domains or otherwise malicious) or having other characteristics/profiles is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed network traffic sample (e.g., a newly analyzed domain for a particular network traffic sample, such as a DNS request or DNS response), security platform 140 (e.g., network traffic classification service 138) sends an indication that network activity (e.g., other network traffic samples) associated with the domain are associated with, or otherwise correspond to, the determined classification. Security platform 140 can provide an indication that network traffic matching the network traffic sample predicted to be malicious (e.g., network traffic matching a domain predicted to be a squatting domain) is to be handled as a malicious network traffic. For example, security platform 140 determines (e.g., computes) a signature or identifier for the network traffic/activity (e.g., a hash or other signature, or identifier for the corresponding network session or domain), and sends to a network node (e.g., a security entity, an endpoint such as a client device, etc.) an indication of the classification associated with the signature (e.g., an indication whether the network traffic/activity is a malicious or non-malicious). Security platform 140 may update a mapping of signatures to network traffic sample classifications and provide the updated mapping to the security entity. In some embodiments, security platform 140 further provides to the network node (e.g., security entity, client device, etc.) an indication of a manner by which network traffic/activity matching the network traffic sample or otherwise be associated with the same session as the network traffic sample classified as malicious or matching the signature is to be handled. For example, security platform 140 provides to the security entity a traffic handling policy, a security policy, or an update to a policy.

According to various embodiments, in response to determining the maliciousness classification for a network traffic sample (e.g., obtaining the predicted maliciousness classification, such as from a classifier), network traffic classification service 138 provides an indication of the maliciousness classification, such as to the applicable security entity (e.g., the security entity that provided the network traffic sample or a security entity mediating network traffic for the session associated with the network traffic sample).

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within enterprise network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable. In some embodiments, IoB detector service 170 is implemented at enterprise DNS server 122 rather than, or in addition to, being implemented at security platform 140.

As mentioned above, in order to connect to a legitimate domain (e.g., www. example. com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite. com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

According to various embodiments, a security entity and/or network node (e.g., a client, device, etc.) handles a file based at least in part on an indication that the file is malicious and/or that the file matches a file indicated to be malicious. In response to receiving indication that the file (e.g., the sample is malicious), the security network and/or network node may update a mapping of files to an indication of whether the corresponding file is malicious, and/or a blacklist of files. In some embodiments, the security entity and/or the network node receives a signature pertaining to a file (e.g., a sample deemed to be malicious), and the security entity and/or the network node stores the signature of the file for use in connection with detecting whether files obtained, such as via network traffic, are malicious (e.g., based at least in part on comparing a signature generated for the file with a signature for a file comprised in a blacklist of files). As an example, the signature may be a hash.

Security entities (e.g., firewalls) typically deny or permit network transmission based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QoS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content-not just ports, IP addresses, and packets-using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provide higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

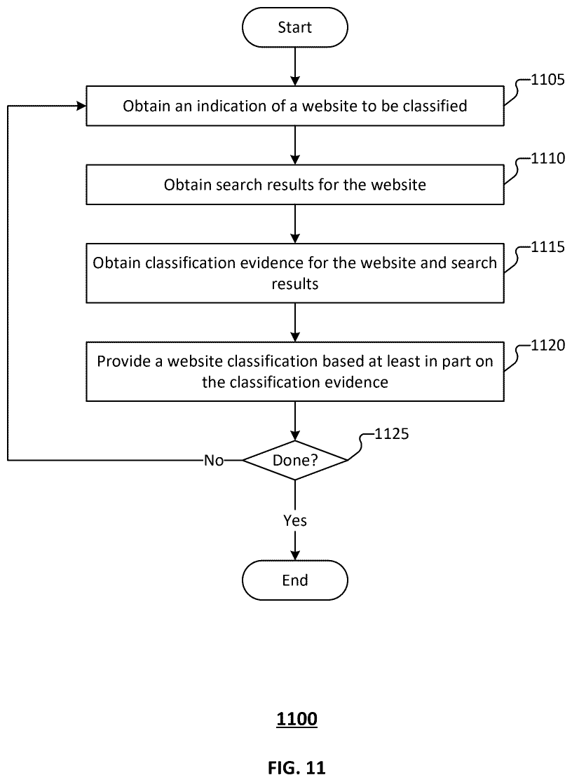

FIG. 2 is a flow diagram of a method for performing a website classification according to various embodiments. According to various embodiments, process 200 is implemented at least in part by one or more of system 100 of FIG. 1. In some embodiments, process 200 is implemented by a network security service, such as security platform 140 of system 100. In some embodiments, process 200 is implemented at an inline security entity, such as a firewall or a client software running at a client system, such as in a security service enforced for a web browser running at the client system. Process 200 can be implemented in connection processes 1100-1800 of FIGS. 11-18.

At 205, the system obtains a set of target domains for which the system is to perform a website classification. For example, the system obtains a set of detected domains (e.g., domains collected by an inline security entity) and provides those detected domains for which a website classification is to be determined to detect whether a classification using a different classifier (e.g., an inline classifier implemented by an inline security entity, an offline or real time classifier implemented by a cloud service, etc.) is false positive or false negative. In response to obtaining the set of target domains, at 210, the system queries a search engine to obtain search results for the various target domains. At 215, the system uses an LLM to extract evidence from the search results. For example, the system queries an LLM to analyze the search results for a particular target domain and to extract from the source sites for the search results (e.g., the webpages corresponding to the search results) evidence that is to be used in connection with classifying the target domain (e.g., to determine a website classification or otherwise perform a false negative/false positive detection).

According to various embodiments, the system further refines the accuracy of its website classification by analyzing the evidence source information associated with the collected search results. The sources of evidence typically correspond to the websites identified through the search engine queries, each of which contributes information regarding the target website. Understanding the reliability, reputation, and trustworthiness of these sources can enable ethe system to make more informed classification decisions because it helps determine how much weight or confidence to place in the evidence extracted from each source.

To accomplish this, the system employs a dedicated source analyzer. Returning to the example shown, at 220, the system collects the source information for the evidence source. For example, the information determines characteristics for the source site such as characteristics that are indicative of a trustworthiness or usefulness of the source site. At 225, the system uses a source analyzer to analyze the source information. The source analyzer inspects each source of extracted evidence (e.g., typically, the specific websites from which the initial search result was retrieved) and assesses their credibility and authority. For example, the source analyzer may check if the evidence source is a recognized and reputable industry directory, a news outlet known for rigorous editorial standards, a popular social media platform, or perhaps an open blogging platform that is easily accessible and therefore less inherently reliable. By distinguishing between various levels of source credibility, the source analyzer informs the subsequent classification decision. In some embodiments, the system leverages expert knowledge. For example, at 230, the system can receive feedback from a domain expert in connection with analyzing the evidence sources.

In some embodiments, the system leverages large language models (LLMs) to perform an assisted categorization of each evidence source. The LLM-driven categorization involves placing sources into predefined website or source categories, such as “Business Directory,” “Professional Social Networking,” “Media Outlet,” “Social Media Platform,” “Cybersecurity Intelligence Database,” and others. Through semantic analysis of the content, the context in which the website appears, and historical knowledge obtained through training, the LLM can accurately and automatically assign categories to these sources, further facilitating consistent and systematic evidence evaluation.

Additionally or alternatively, the source analyzer may utilize rule-based or heuristic approaches to assess evidence sources. Heuristic rules can include conditions such as whether a source appears across multiple independent search results or if the website is explicitly listed on known trusted lists or directories. These heuristic criteria may also assess whether the source domain is commonly associated with trustworthy entities (e.g., Crunchbase, ZoomInfo, Yelp) or conversely, if it falls within a group of easily manipulable, publicly accessible platforms such as certain blogging services or social media. This layered combination of LLM-based categorization and heuristic rule application ensures that the system thoroughly evaluates each evidence source, ultimately resulting in more accurate, nuanced, and reliable website classifications.

According to various embodiments, once evidence has been extracted from the search results and associated websites, the system utilizes a dedicated evidence analyzer to interpret and evaluate the significance of this information. At 235, the system obtains the evidence collected (e.g., extracted from the sources associated with the search results) for a particular target domain. At 240, the system uses an evidence analyzer to analyze the evidence for the particular target domain. In some embodiments, the evidence analyzer performs detailed assessments, analyzing multiple dimensions such as the content of the extracted evidence, its context within the original sources, and additional supporting information gathered from knowledge databases or repositories. For example, the analyzer may evaluate URL structures, domain registrations, IP addresses, metadata, textual references, and descriptions of how the target website/domain is mentioned, referenced, or utilized across various third-party sites. In some embodiments, the system leverages expert knowledge. For example, at 230, the system can receive feedback from a domain expert in connection with analyzing the evidence for a target domain/website.

In some embodiments, the evidence analyzer functions similarly to services that detect malicious indicators, systematically examining specific data points to detect patterns indicative of malicious or benign behavior. The evidence analyzer can scrutinize characteristics of URLs, domains, IP addresses, and hosting information, considering signals such as unusual domain naming conventions, questionable hosting providers, or correlations with known malicious infrastructure. By analyzing how the target website is presented and contextualized on third-party websites, the analyzer can identify anomalies, misrepresentations, or reputational clues indicative of potential maliciousness or benign intent.

In various embodiments, the evidence analyzer may employ rule-based or heuristics-based methodologies. These heuristic criteria are explicitly defined rules or guidelines that evaluate evidence based on known best practices or previously observed patterns. For instance, heuristic rules could dictate that a website frequently appearing in reputable third-party directories or consistently referenced positively by trusted media outlets is likely benign, whereas a website associated with suspicious indicators (e.g., short-term registrations, unverified content, or blacklisted IP addresses) may be flagged as malicious or warranting further investigation. By systematically applying these heuristic rules, the evidence analyzer ensures structured and transparent decision-making based on clearly defined criteria.

Additionally or alternatively, certain embodiments implement machine learning (ML) models specifically trained for the task of evidence analysis. These specialized ML models are trained on labeled datasets representing various characteristics of websites, including benign and malicious behavior patterns. During operation, these trained ML models analyze new extracted evidence, automatically classifying or predicting the likelihood of maliciousness based on learned patterns. Employing ML-based approaches allows the system to manage large and complex data sets efficiently, enhancing consistency, accuracy, and scalability in the classification process.

In some embodiments, the system leverages LLMs analyze extracted evidence comprehensively. In some implementations, the LLMs are generic third party LLMs (e.g., Gemini, ChatGPT, Llama, Grok, etc.). In other implementations, one or more of the LLMs are specifically fine-tuned or trained to analyze extracted evidence comprehensively. These LLMs possess advanced semantic understanding capabilities that enable them to interpret nuanced contextual cues within the extracted content, accurately assessing references, descriptions, and usage patterns across third-party sources. With their contextual reasoning ability, these specialized LLMs are particularly adept at distinguishing subtle indicators of legitimate versus potentially malicious behavior, making them highly effective in evidence evaluation tasks that require understanding complex textual and contextual information. Thus, integrating tailored LLMs into the evidence analysis process ensures deep, context-aware evaluations that significantly enhance the accuracy and reliability of website classifications.

After the evidence sources and the extracted evidence have been separately analyzed, the system integrates these two sets of analysis outputs to form a comprehensive assessment. At 245, the system uses a result classifier to integrate/combine the analysis outputs from (e.g., the classification information) from the source analyzer and the evidence analyzer. By combining the insights from the source analyzer, which evaluates the credibility, category, and reliability of each evidence source, with the evidence analyzer's detailed interpretations of content, context, and explicit domain or URL indicators, the system achieves a nuanced understanding of the target website's legitimacy or potential maliciousness. The combination process ensures that neither dimension (e.g., source credibility nor content analysis) is considered in isolation, significantly enhancing the accuracy and confidence in the final classification outcome. At 250, the system stores the final classification outcome (e.g., the website classification) in a trusted database. This final classification outcome can be used to detect false positives or false negatives. In some embodiments, the system updates an allowlist or a denylist based on the final classification outcome.

In some embodiments, the system employs an advanced large language model (LLM) specifically to synthesize and integrate the outputs of the source analyzer and the evidence analyzer. This LLM is provided with structured or semi-structured data summarizing the credibility categories, heuristic evaluations, and reliability scores of each source, as well as detailed contextual interpretations, domain features, usage patterns, and semantic analysis results obtained from the evidence analyzer. Using its contextual reasoning abilities, the LLM integrates these multi-dimensional data points to draw an informed conclusion about whether the website should be classified as benign or malicious (e.g., to determine the website classification for a target domain). Leveraging the interpretive capabilities of an LLM in this integrative step allows the system to consider subtle interdependencies and complex contextual cues, resulting in sophisticated classifications.

The LLM implemented to combine the analytical results can be the same model used during earlier stages of evidence extraction and source categorization or, alternatively, it may be a distinct LLM (e.g., specifically fine-tuned to perform integration and classification tasks). In scenarios where the same LLM is used throughout the pipeline, the model benefits from retaining context and prior reasoning, providing consistency and continuity across analytical stages. Conversely, employing a specialized LLM trained specifically for the integration and classification stage may offer greater specialization and accuracy in synthesizing diverse analytical inputs.

According to various embodiments, through use of an LLM-driven combination of both evidence source credibility and detailed content analysis, the system achieves enhanced reliability and accuracy in its website classification outcomes. This combined analytical approach effectively minimizes false positives and negatives by rigorously evaluating multiple dimensions of evidence simultaneously, thereby significantly improving cybersecurity measures and ensuring a more trustworthy classification process.

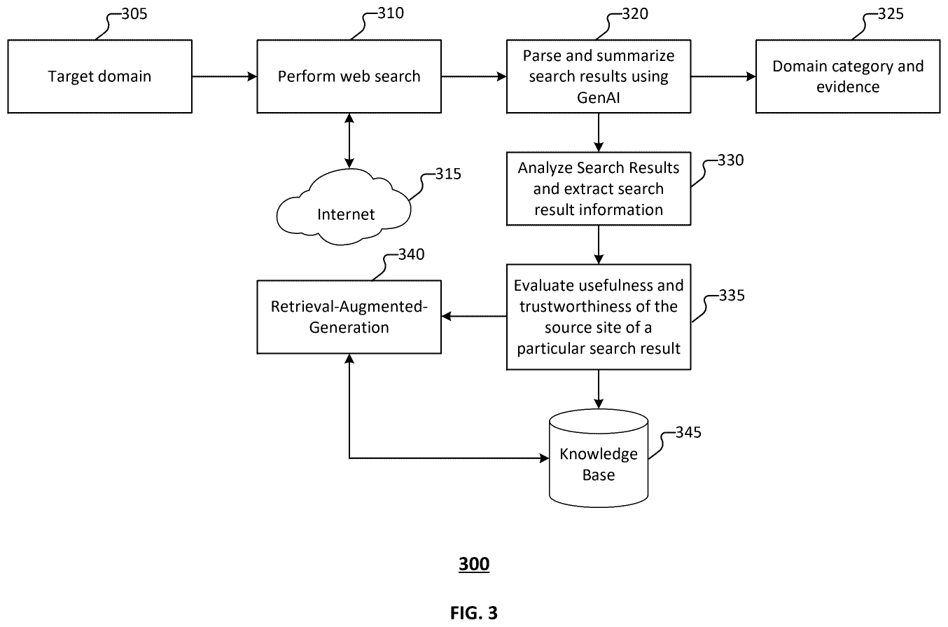

FIG. 3 is a flow diagram of a method for performing a website classification according to various embodiments. According to various embodiments, process 300 is implemented at least in part by one or more of system 100 of FIG. 1. In some embodiments, process 300 is implemented by a network security service, such as security platform 140 of system 100. In some embodiments, process 300 is implemented at an inline security entity, such as a firewall or a client software running at a client system, such as in a security service enforced for a web browser running at the client system. Process 300 can be implemented in connection with process 200 FIG. 2, and/or processes 1100-1800 of FIGS. 11-18.

At 305, the system obtains a set of one or more target domains. According to various embodiments, the system obtains indications of target websites (e.g., target domains) for classification through several distinct methods, depending on the particular implementation and/or specific requirements of the cybersecurity environment. One method for receiving target websites/domains method comprises receiving indications of websites or domains directly from outputs generated by existing maliciousness detection services (e.g., other classifiers, such as rule-based classifiers, machine learning based classifiers, etc.). For example, an inline maliciousness detector (e.g., such as a network-based security monitor implemented at an inline security entity) may flag certain domains/websites as potentially malicious (e.g., based on preliminary heuristics, threat intelligence feeds, and/or pre-trained classifiers). The system then selects these flagged websites as targets for further analysis, performing post-processing to validate or correct the initial classification, particularly to identify and remediate any false positives that might disrupt legitimate activities, or any false negatives.

Additionally, or alternatively, the system can obtain indications of target websites from a set of websites/domains explicitly identified by clients or customers of cybersecurity services. In such implementations, a client or security analyst provides a predefined list of websites/domains that require deeper inspection or verification, such as those belonging to new business partners, recently observed suspicious domains, or websites identified in internal investigations. By directly specifying these domains, clients can ensure targeted and efficient security assessments, leveraging the system's comprehensive analytical capabilities to rapidly and accurately classify websites of particular relevance or concern to their organization.

Additionally or alternatively, the system can automatically obtain target websites/domains by intercepting and analyzing various forms of network communications. For example, the system or an associated security service may intercept emails, text messages, instant messages, or attachments containing embedded URLs. Upon extracting these URLs, the system automatically designates them as target websites requiring classification. This automated extraction approach enables proactive, real-time detection and assessment of potentially malicious websites included within user communications, thereby facilitating prompt responses to emerging threats and mitigating potential security risks at the earliest possible stage.

In practice, these techniques can be employed individually or collectively, enabling the system to flexibly adapt to diverse cybersecurity scenarios. Whether verifying the accuracy of automated maliciousness detections, responding to client-specific cybersecurity priorities, or proactively intercepting and analyzing embedded threats in network traffic, the system consistently obtains relevant target websites in an efficient, comprehensive manner, laying the foundation for accurate and reliable website classification outcomes.

Returning to the example shown, in response to receiving the set of target domains, at 310, the system perform a web search based on the set of target domains. For example, the system can iteratively perform a web search for teach of the target domains in the set of target domains. Performing the web search may include querying a search engine via the internet at 315. In some embodiments, the system queries a particular search engine for a set of results for a particular target domain. In some embodiments, the system queries one or more search engines (e.g., a predefined set of search engines, or a set of search engines selected from a predefined list of search engines) for a set of search results for the particular target domain. The system receives a set of search results from a search engine(s). At 320, the system parses and summarizes the search results. In some embodiments, the system uses GenAI to parse and summarize the search results. For example, the system can query an LLM to obtain search result information based on the set of search results. At 325, the system can categorize the search result(s) based on the information obtained by parsing and/or summarizing the search result. In some embodiments, the system categorizes the target domain by querying an LLM to determine a category for the target domain based on the search results (e.g., source information obtained for the search results). The category may be selected from a predefined list of categories. According to various embodiments, the system uses (e.g., queries an LLM or other analyzer service to analyze) the search results and source context, and categorize the target domain, and output any discovered sources as descriptive evidence. At 330, the system analyzes the search results and extracts search result information. The system extracts evidence (e.g., classification evidence) from the search result such as the website corresponding to the search result. For example, the system can extract classification evidence with which the system determines a website classification (e.g., evidence used by an LLM to generate a classification based on an analysis of source information and the extracted evidence). In some embodiments, the system uses a machine learning model, such as an LLM, to extract the classification evidence. For example, the system prompts an LLM to analyze the website for the search result (e.g., the source site) and extract relevant information to be used in connection with classifying the website. In other embodiments, the system may implement one or more predefined rules or heuristics to extract information from the search result. At 335, the system evaluates the usefulness and trustworthiness of the source site of a particular search result. In some embodiments, the system implements a source analyzer to analyze the source information for the source site in connection with detecting characteristics of the source that are indicative that the source site is malicious or benign. For example, the system can generate a trustworthiness or legitimacy score according to a predefine scoring function. As another example, the system can generate a feature vector representing the source site. At 345, the system can store in a knowledge base the classification information obtained based on analyzing the source site. At 340, the system implements a retrieval-augmented generation (RAG) technique to identify other supplemental information or other sources comprising information pertaining to the target domain or the source site for the applicable search result.

According to various embodiments, if the source site (e.g., the website comprising a reference to the target domain) is a source of public intelligence (e.g., popular lists or known infrastructure lists, etc.), leverage GenAI (e.g., an LLM) to automatically collect all other domains from the source or identify ways to collect the other domains. The system can implement iterative prompting of GenAI models (e.g., an LLM) and perform RAG from additional knowledge stores to collect information on the search result sites and content to improve accuracy.

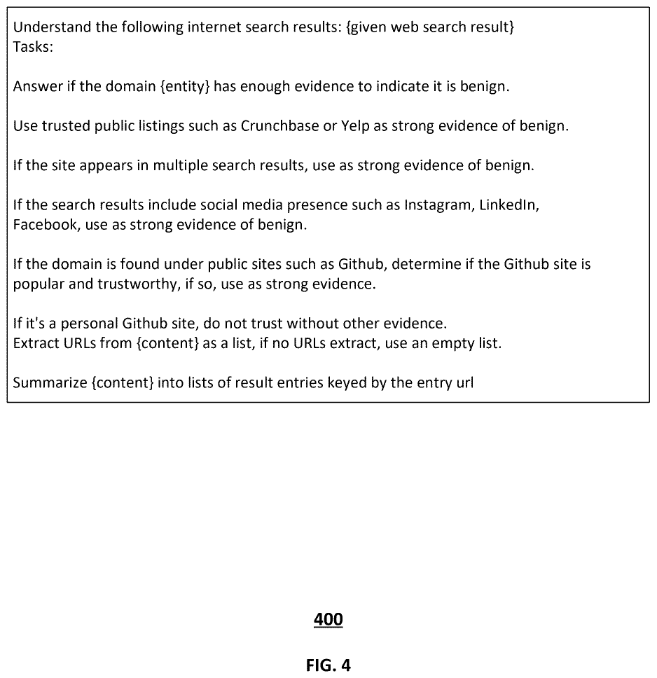

FIG. 4 is an example of a prompt for training a machine learning model to perform a domain classification according to various embodiments. In some embodiments, the system implements prompt 400 to train an LLM to determine a website classification, such as whether a target domain is malicious or benign, or to detect a false positive or false negative with respect to a network traffic sample classification (e.g., obtained by another classifier) for the target domain. The system can instruct the LLM to extract classification evidence for the search results, such as by instructing the LLM how to extract the evidence or the types of evidence to extract.

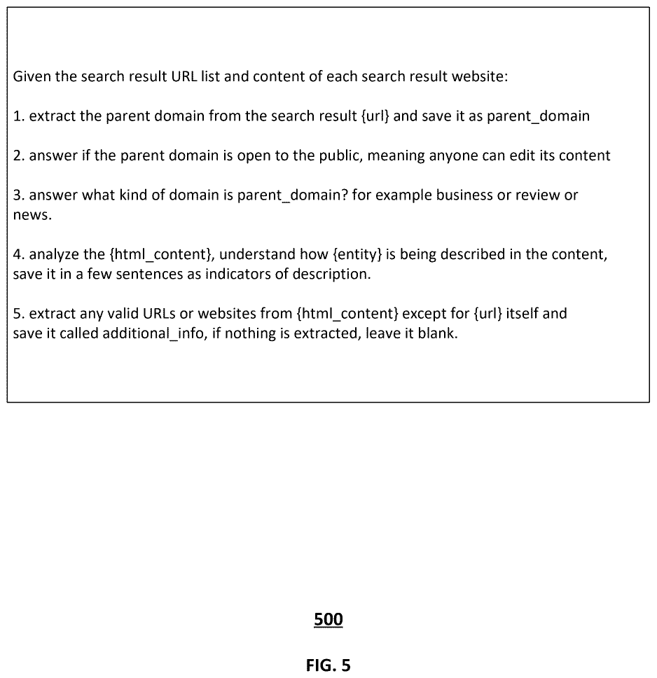

FIG. 5 is an example of a prompt for requesting a machine learning model to extract classification evidence based on search results for a domain according to various embodiments. In some embodiments, the system queries an LLM based on prompt 500 to extract evidence from a search result returned from a search engine for a query with respect to a target domain.

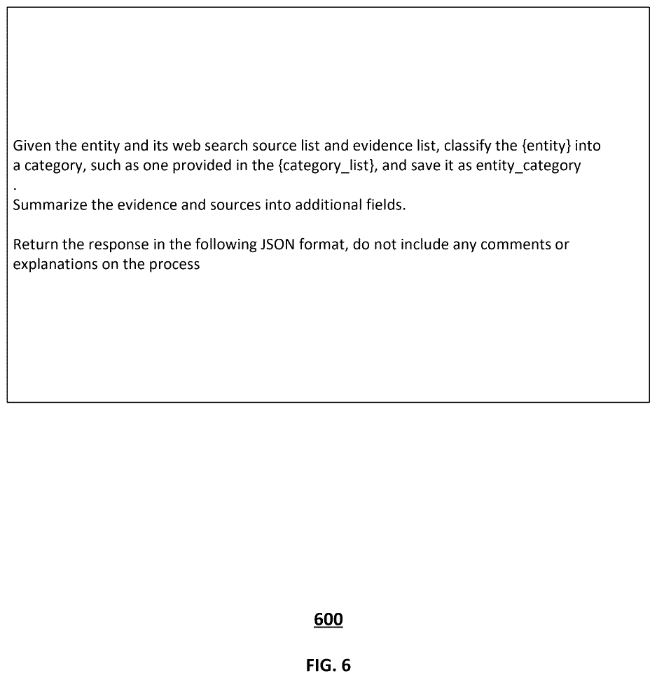

FIG. 6 is an example of a prompt for determining a domain classification based on an analysis of source information and an analysis on classification evidence according to various embodiments. According to various embodiments, the system can prompt a machine learning model, such as an LLM, to combine results of a source analysis and results of evidence analysis (e.g., to combine the results/classification information obtained by analyzing the sources of classification device, and the evidence extracted from the sources). As an example, the system can prompt the LLM using prompt 600, such as “given the entity and its web search source list and evidence list, classify the {entity} into a category, such as one provided in the {category_list}, and save it as entity_category. Summarize the evidence and sources into additional fields. Return the response in the following JSON format, do not include any comments or explanations on the process.”

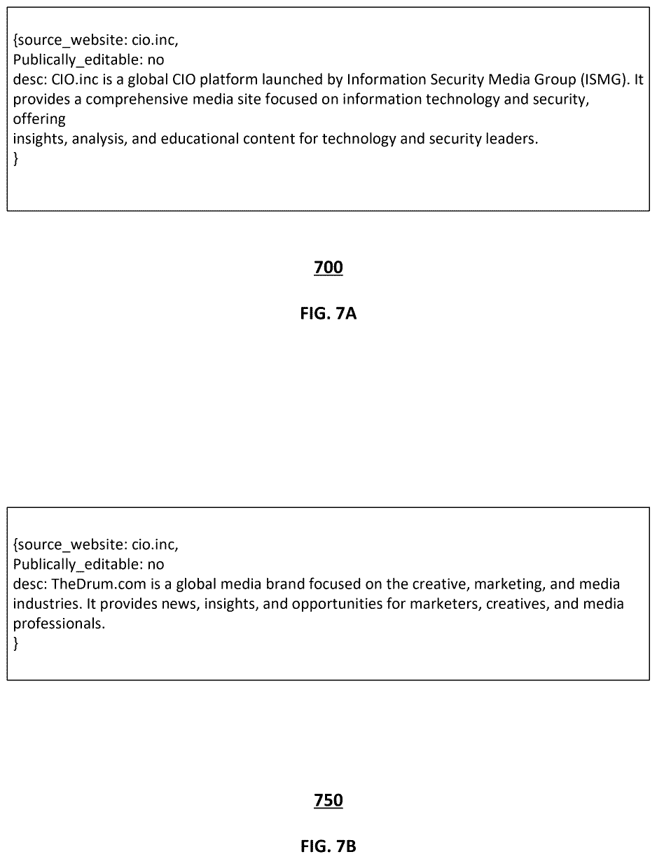

FIGS. 7A and 7B are examples of source information that are analyzed in connection with determining a domain classification according to various embodiments.

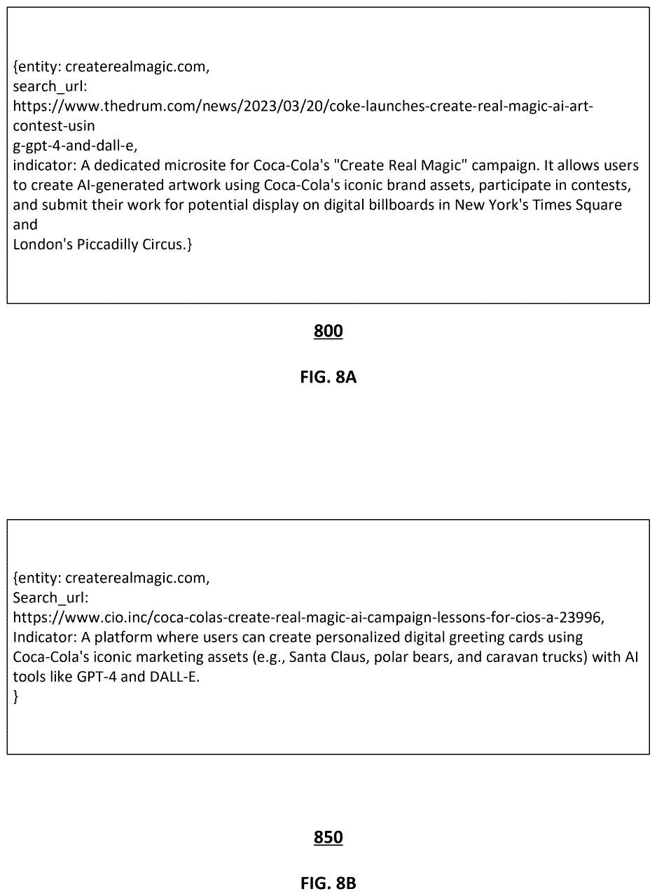

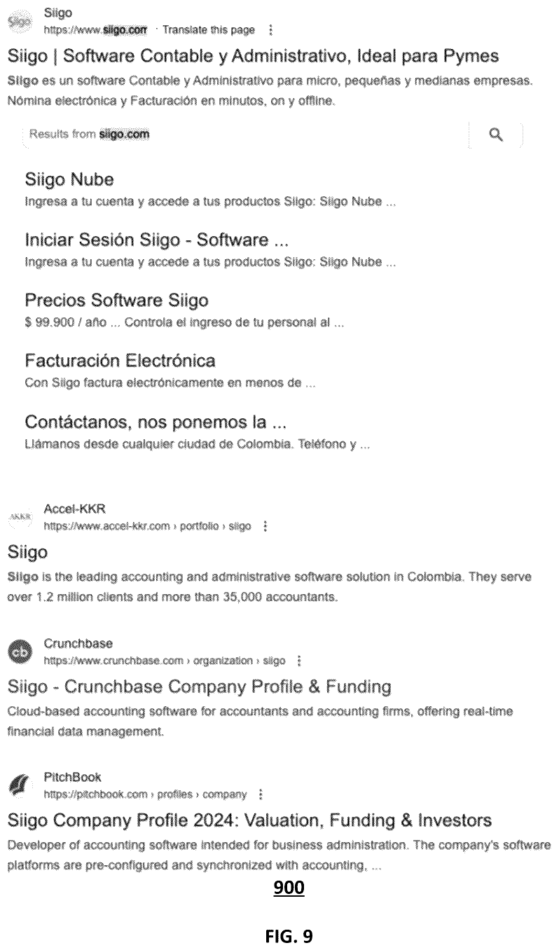

FIGS. 8A and 8B are examples of classification evidence that are extracted based on search query results and analyzed in connection with determining a domain classification according to various embodiments.

FIG. 9 is an example of search results obtained in connection with determining a domain classification according to various embodiments. In the example shown, the system has queried a search engine (e.g., Google) based on the target domain siigo.com, and the search engine has returned a set of search results comprising information pertaining to the target domain, such as the target domain's website, Crunchbase, Pitchbook, etc.

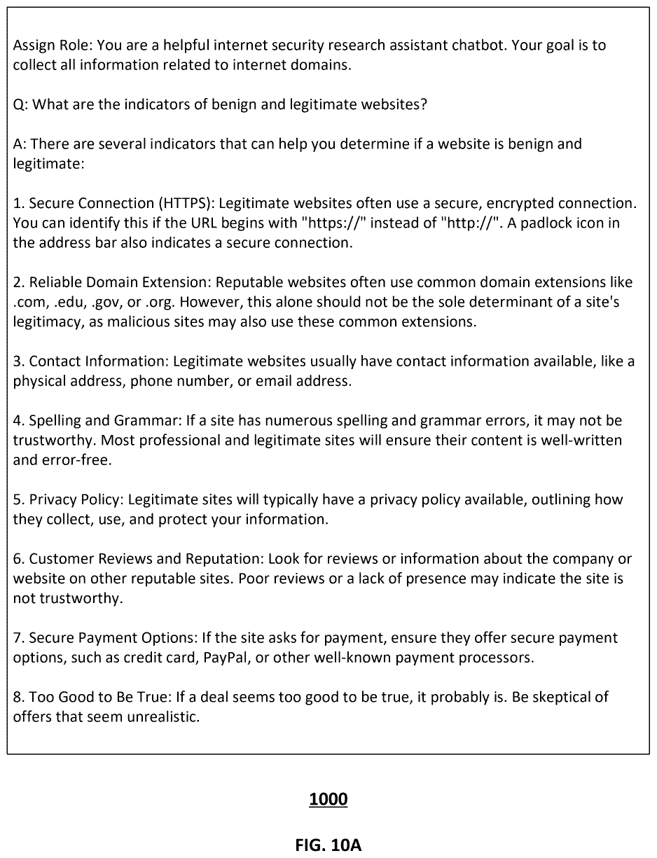

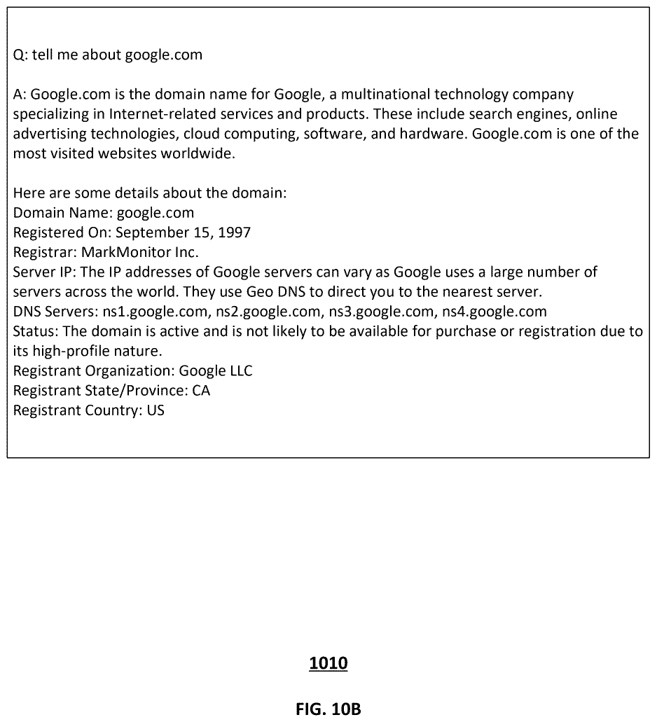

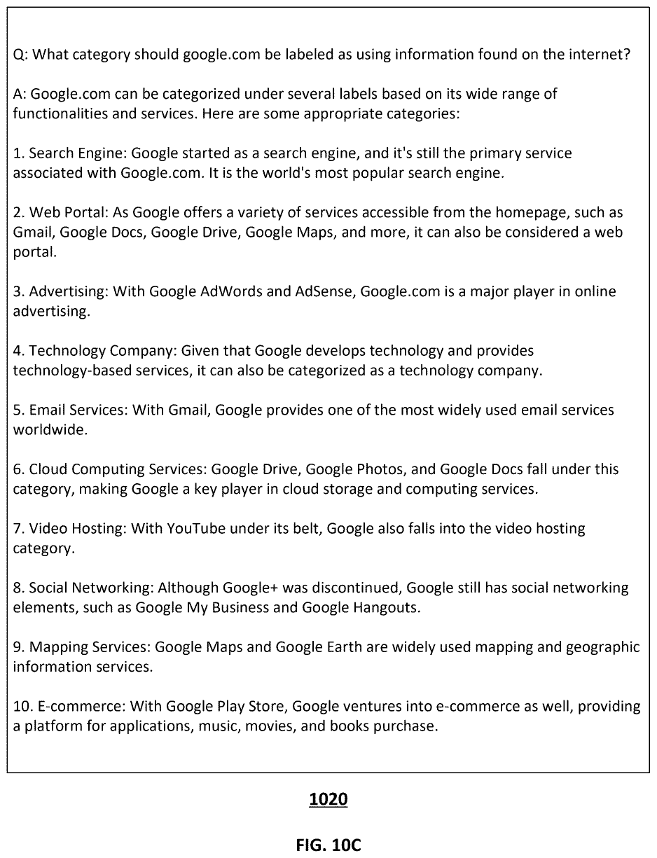

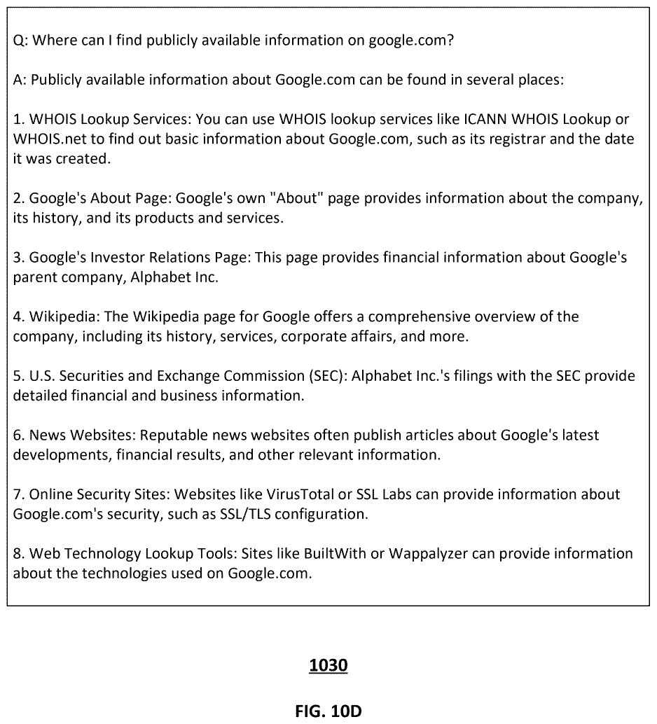

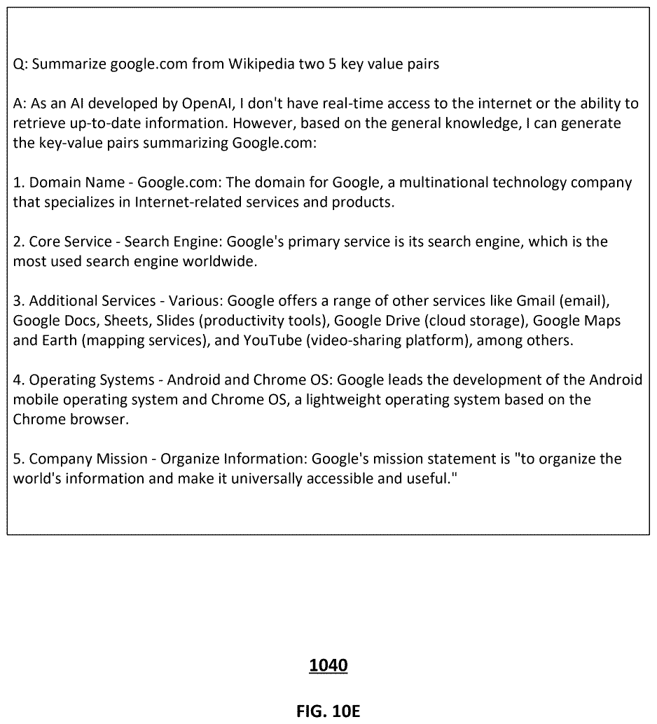

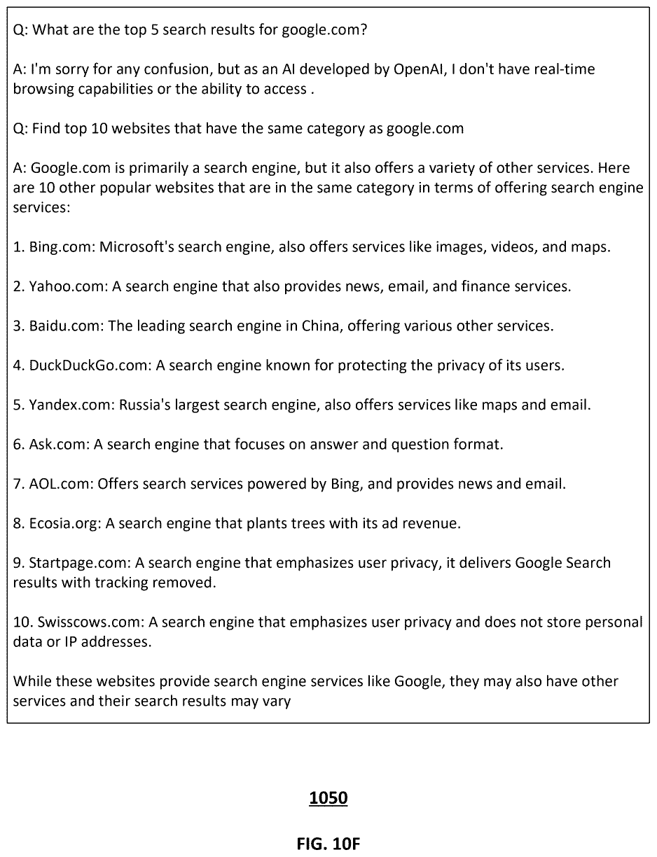

FIGS. 10A-10F are examples of prompts used in connection with using a machine learning model to obtain a domain classification according to various embodiments.

The system can implement prompt 1000 in connection with analyzing each source (e.g., the sources associated with the search results) to determine whether the source is to be deemed a trusted source for benign indicators (e.g., IoBs). The system collects the web content and leverages AI (e.g., GenAI) to understand why the target domain is mentioned in the search result(s). In the example shown, prompt 1000 includes responses provided by the AI (e.g., a machine learning model such as an LLM). Examples of IoBs that an LLM may identify include (a) whether a secure connection is used, (b) whether a reliable domain extension is used, (c) contact information for the domain/website of a particular search result, (d) spelling and grammar of content comprised in the source object (e.g., a website, a document, etc.) for the search result, (e) a privacy policy associated with the search result, (f) a customer review and/or reputation for the source object, (g) whether the website for the search result uses a secure payment option, and/or (h) an evaluation of whether content is an outlier (e.g., a statistically relevant outlier) such as the content including a deal that is too good to be true.

The system can implement prompt 1010 in connection with collecting source information for a source of classification evidence (e.g., evidence extracted from a search result). For example, the system can query a machine learning model to collect the source information or supplemental information, such as based on querying one or more third-party sources/services, or performing a RAG technique to collect supplemental information from a knowledgebase of documents or information collected by other sources or services. In the example shown, the system collects registration information for the domain associated with a search result or source of classification evidence.

The system can implement prompt 1020 in connection with determining a categorization for the source. For example, the system queries the machine learning model (e.g., an LLM) to categorize the source (e.g., assign a category label for the source). The system can implement the LLM to determine a single category for a source or a plurality of categories for the source. In some embodiments, the system implements a predefined list of categories and queries the LLM to categorize a source to one or more of the categories in the list of categories.

The system can implement prompt 1030 in connection with identifying source information or sources for source information (e.g., sources from which the system can obtain supplemental information for a website associated with a search result). In some embodiments, in response to identifying the other sources of source information, the system can query those sources to collect source information for the source from which classification evidence is extracted (e.g., the website associated with a search result).

The system can implement prompt 1040 in connection with collecting source information for a source identified by a search result (e.g., the website associated with a search result). For example, the system can query the LLM to extract information from source information or sources for source information (e.g., sources from which the system can obtain supplemental information for a website associated with a search result). In the example shown, the system queries the LLM to summarize the information pertaining to the source identified by a search result.

According to various embodiments, once a source (e.g., Crunchbase) is determined to contain valuable benign evidence (e.g., the source is deemed to be trustworthy or having an associated trustworthiness exceeding a trustworthiness threshold), the system collects all domains from this source. As an example, to facilitate the automation of this information collection, the system can leverage tools such as an LLM (e.g., ChatGPT, Gemini, Llama, Grok, etc.). The system can implement the LLM to automatically generate prompts to (a) obtain a list of domains, and (b) obtain an indication of whether an API is available for use to download/obtain data from the source. The system can then onboard the source for source information associated with future search results.

The system can implement prompt 1050 in connection with identifying other sources of information that may be used for classification evidence.

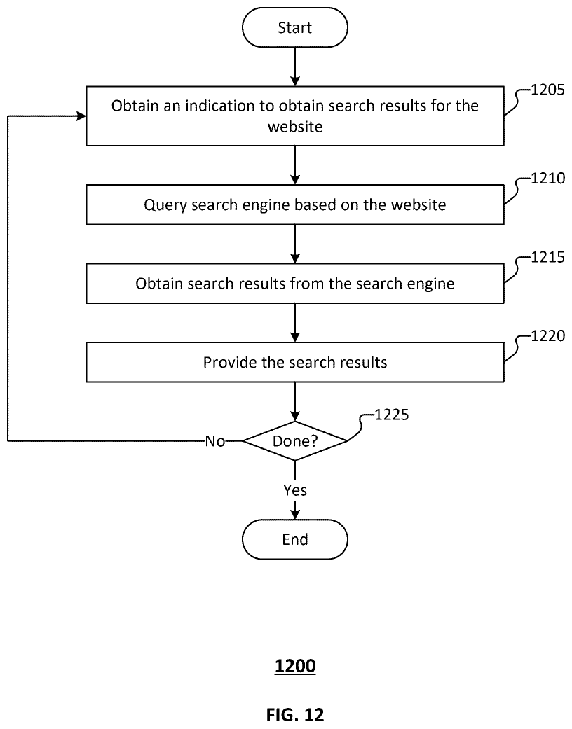

FIG. 11 is a flow diagram of a method for obtaining a domain classification for a particular domain according to various embodiments. According to various embodiments, process 1100 is implemented at least in part by one or more of system 100 of FIG. 1. In some embodiments, process 1100 is implemented by a network security service, such as security platform 140 of system 100. In some embodiments, process 1100 is implemented at an inline security entity, such as a firewall or a client software running at a client system, such as in a security service enforced for a web browser running at the client system. Process 1100 can be implemented in connection with process 200 FIG. 2, process 300 of FIG. 3, and/or processes 1200-1800 of FIGS. 12-18. In some embodiments, process 1100 is invoked by process 1800, such as at 1820.

At 1105, the system obtains an indication of a website to be classified. At 1110, the system obtains search results for the website. At 1115, the system obtains classification evidence for the website search results. The system can obtain the classification evidence by querying one or more search engines and extracting classification evidence from the search results (e.g., the websites for the search results), and in some embodiments, supplemental information for the search results. The system can implement a machine learning model, such as an LLM, to extract the classification evidence based on the search results. At 1120, the system provides the website classification based at least in part on the classification evidence. In some embodiments, the system implements a machine learning model (e.g., an LLM) to classify the target domain(s) (e.g., to determine corresponding website classifications). For example, the system queries an LLM for the classification of the target domain (e.g., to detect whether the target domain is malicious or benign and/or whether a classification using other techniques is a false positive or false negative). The system can use the website classification to detect a false positive or in connection with determining to how to handle a network traffic sample or network traffic to the domain. In response to determining the website classification for a target domain, the system can cause network traffic for the target domain to be handled accordingly. For example, the system can update an allowlist (e.g., a whitelist) and/or a denylist (e.g., a blacklist), which can be referenced/queried to determine how to handle traffic for the target domain. The allowlist or denylist can be provided (e.g., pushed) to security entities for local/inline enforcement of security policies according to these classifications.

At 1125, the system determines whether process 1100 is complete. In some embodiments, process 1100 is determined to be complete in response to a determination that no further website classifications are to be performed, no further websites/domains are to be evaluated/analyzed, the website classification has been stored and/or used to update systems enforcing security policies (e.g., to update allowlists or denylists), an administrator indicates that process 1100 is to be paused or stopped, etc. In response to a determination that process 1100 is complete, process 1100 ends. In response to a determination that process 1100 is not complete, process 1100 returns to 1105. In some embodiments, rather than performing 1125, process 1100 ends upon determination that all website(s)/domain(s) have been processed to identify search results, the classification evidence has been extracted from all relevant search results for the website(s)/domain(s) to be analyzed, etc.

FIG. 12 is a flow diagram of a method for obtaining search results for a domain according to various embodiments. According to various embodiments, process 1200 is implemented at least in part by one or more of system 100 of FIG. 1. In some embodiments, process 1200 is implemented by a network security service, such as security platform 140 of system 100. In some embodiments, process 1200 is implemented at an inline security entity, such as a firewall or a client software running at a client system, such as in a security service enforced for a web browser running at the client system. Process 1200 can be implemented in connection with process 200 FIG. 2, process 300 of FIG. 3, and/or process 1100 of FIG. 11. In some embodiments, process 1200 is invoked by process 1100, such as at 1110.

Upon obtaining an indication of a target website for classification, the system initiates a process to collect relevant online contextual information by querying one or more search engines.

In some embodiment, the system queries a single search engine (e.g., Google, Bing, DuckDuckGo, Yahoo!, etc.) by providing (e.g., querying based on) the target website's domain name or related identifying information. This focused approach yields a straightforward set of search results, enabling the system to efficiently gather initial evidence about how the target website is referenced, described, or utilized on the broader internet.

In some embodiments, the system queries multiple search engines simultaneously or sequentially, including popular search engines such as Google, Bing, DuckDuckGo, Yahoo, or other specialized search services. Leveraging multiple search engines can be advantageous because each search engine indexes different subsets of the internet, potentially offering distinct and complementary perspectives on the target website's online presence. The querying of a plurality of search engines to collect search results for a target domain broadens scope of search enhances the diversity and comprehensiveness of the collected results, which can strengthen subsequent analyses and the accuracy of the final classification (e.g., the website classification such as to detect whether the target domain is malicious or benign, etc.).

In response to the search engines returning the results from querying based on the target domain(s), the system compiles these into a defined set of search results for further examination. In some implementations, the system utilizes all results provided by the queried search engines. This approach is particularly useful when thoroughness or maximal breadth is desired, and the system intends, or is configured, to capture as much available context and detail about the target website as possible.

Alternatively, in some embodiments, the system applies a configurable threshold number of results to limit the collected dataset. The threshold number of top results (or threshold percentage of top results) retained for analysis may be predefined according to the system's operational parameters or tailored to specific security requirements. Typical threshold values could range from the top 10, 25, or 50 results, etc. (e.g., the top ranked results, etc.). The system can be configured to implement this selective approach to balance comprehensiveness with operational efficiency, ensuring the system remains scalable and practical while still capturing a representative and informative subset of the available contextual information.

Returning to the example shown, at 1205, the system obtains an indication to obtain search results for the website. At 1210, the system queries a search engine(s) based on the website. For example, the system queries the search engine for a set of search results based on the website name and/or domain. At 1215, the system obtains search results from the search engine. At 1220, the system provides the search results. At 1225, the system determines whether process 1200 is complete. In some embodiments, process 1200 is determined to be complete in response to a determination that no further classification evidence is to be obtained, no further search results or classification evidence is to be obtained for a website/domain, no further website/domains are to be analyzed, an administrator indicates that process 1200 is to be paused or stopped, etc. In response to a determination that process 1200 is complete, process 1200 ends. In response to a determination that process 1200 is not complete, process 1200 returns to 1205. In some embodiments, rather than performing 1225, process 1200 ends upon determination that all website(s)/domain(s) have been processed to identify search results, the classification evidence has been extracted from all relevant search results for the website(s)/domain(s) to be analyzed, etc.

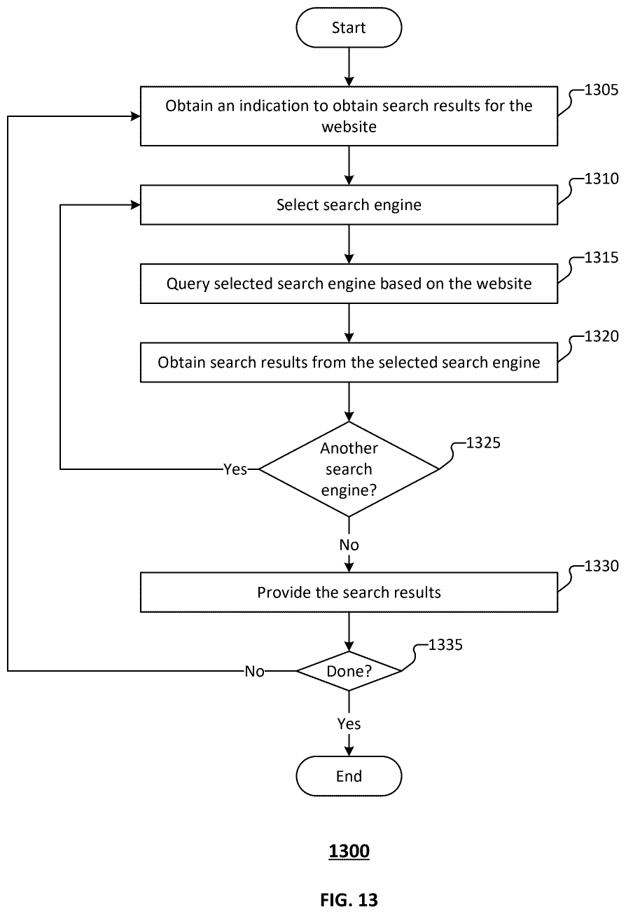

FIG. 13 is a flow diagram of a method for obtaining search results for a domain according to various embodiments. According to various embodiments, process 1300 is implemented at least in part by one or more of system 100 of FIG. 1. In some embodiments, process 1300 is implemented by a network security service, such as security platform 140 of system 100. In some embodiments, process 1300 is implemented at an inline security entity, such as a firewall or a client software running at a client system, such as in a security service enforced for a web browser running at the client system. Process 1300 can be implemented in connection with process 200 FIG. 2, process 300 of FIG. 3, and/or process 1100 of FIG. 11. In some embodiments, process 1300 is invoked by process 1100, such as at 1110.

At 1305, the system obtains an indication to obtain search results for the website. At 1310, the system selects a search engine, for example, from a plurality of predefined search engines. At 1315, the system queries a selected search engine based on the website. At 1320, the system obtains search results from the selected search engine. At 1325, the system determines whether another search engine is to be queried. In response to determining that another search engine is to be queried, process 1300 returns to 1310 and process 1300 iterates over 1310-1325 until no further search engines are to be queried. Conversely, in response to determining that no further search engines are to be queried, process 1300 proceeds to 1330 at which the system provides the search results. At 1335, the system determines whether process 1300 is complete. In some embodiments, process 1300 is determined to be complete in response to a determination that no further classification evidence is to be obtained, no further search results or classification evidence is to be obtained for a website/domain, no further website/domains are to be analyzed, an administrator indicates that process 1300 is to be paused or stopped, etc. In response to a determination that process 1300 is complete, process 1300 ends. In response to a determination that process 1300 is not complete, process 1300 returns to 1305. In some embodiments, rather than performing 1335, process 1300 ends upon determination that the classification evidence has been extracted from all relevant search results for the website(s)/domain(s) to be analyzed.

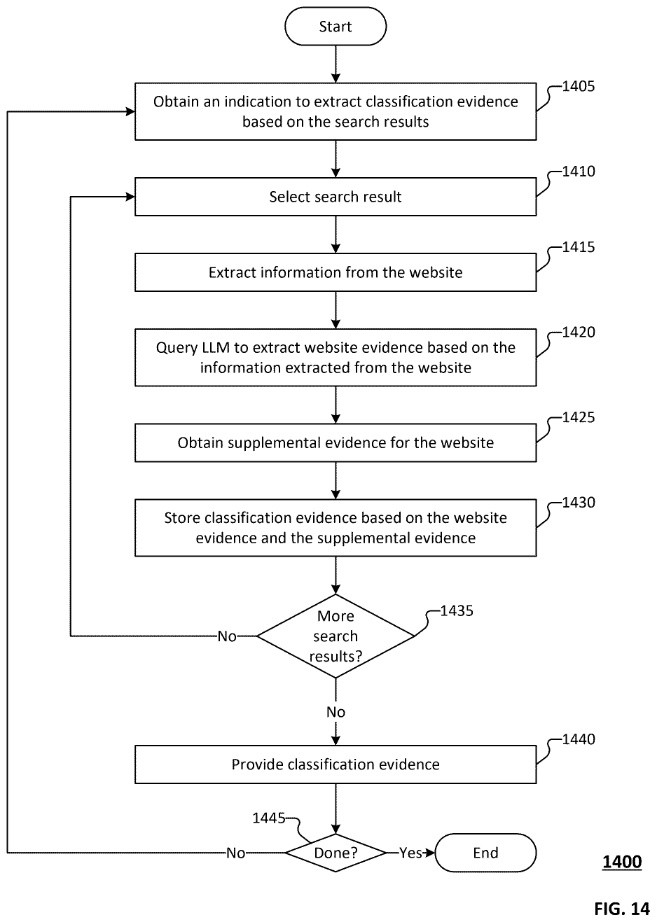

FIG. 14 is a flow diagram of a method for obtaining classification evidence associated with search results for a particular domain according to various embodiments. According to various embodiments, process 1400 is implemented at least in part by one or more of system 100 of FIG. 1. In some embodiments, process 1400 is implemented by a network security service, such as security platform 140 of system 100. In some embodiments, process 1400 is implemented at an inline security entity, such as a firewall or a client software running at a client system, such as in a security service enforced for a web browser running at the client system. Process 1400 can be implemented in connection with process 200 FIG. 2, process 300 of FIG. 3, and/or process 1100 of FIG. 11. In some embodiments, process 1400 is invoked by process 1100, such as at 1115.

According to various embodiments, in response to obtaining a defined set of search results for a target website (e.g., a website associated with a network traffic sample being classified), the system proceeds to collect (e.g., extract) detailed evidence from these search results to support subsequent website classification. In one implementation, the system iteratively navigates directly to each website associated with the search results, systematically extracting relevant information, including textual content, metadata, page context, and references to the target website. The system can directly examining the content of each identified webpage, and thus gather concrete, detailed evidence that captures how the target website is discussed, referenced, or utilized across various online sources.

In some embodiments, the system implements an LLM to facilitate and enhance this evidence extraction process. Specifically, the LLM analyzes the collected search results to intelligently extract and interpret relevant information. The LLM can parse the descriptions and snippets returned by search engines, identifying details about the sources themselves, such as their website categories, credibility indicators, or reputational context. Through semantic understanding, the LLM accurately identifies relevant evidence and contextual nuances from these search result snippets, ensuring a more thorough and nuanced initial extraction than keyword-based or heuristic approaches.

Additionally, or alternatively, the LLM can perform deeper analyses by examining the actual webpage content linked from the search results. In such embodiments, the system leverages the LLM's ability to understand textual and contextual cues from full webpages, extracting information such as detailed descriptions, mentions of the target website's purpose or function, indications of legitimacy, reputational signals, or potential security-related indicators. The LLM can also extract context information, for example, to precisely identify how the target website is related or referenced in relation to other content on the webpage. This contextual analysis helps ensure that the evidence collected is both relevant and precisely understood, facilitating more accurate downstream classification.

In some embodiments, the system uses an LLM for both source information extraction and detailed content analysis, thereby enhancing its ability to gather comprehensive, context-rich evidence. This integrated LLM-driven evidence collection technique enables the system to capture nuanced, highly informative data points that are critical for subsequent analyses. As a result, the collected (e.g., extracted) evidence set is not only broad and diverse, but also finely tuned to reflect the complex relationships and reputational insights to be used for accurate and reliable website classification decisions.

According to various embodiments, the system identifies/determines that particular websites associated with search results constitute authoritative or reputable sources of public intelligence, such as widely recognized infrastructure lists, cybersecurity trust lists, domain registries, or popular curated directories. Recognizing the unique value and reliability inherent in these intelligence sources, the system leverages specialized Generative AI (GenAI) techniques to automatically and systematically gather supplemental information beyond the initial data extracted from search results. This supplemental evidence can be used to significantly expand the depth and accuracy of the contextual understanding related to the target website.

In response to identifying (e.g., obtaining) a search result website as a public intelligence source, the system implements GenAI models (e.g., particularly LLMs) to iteratively parse and analyze the source in greater depth. For instance, the system may prompt the GenAI model/service to extract comprehensive lists of other domains or URLs explicitly included in or linked from the intelligence source. In doing so, the GenAI model can intelligently recognize and extracts relevant patterns, context, and information, thereby expanding the scope of evidence beyond the original search result and enriching the overall data available for classification.

Additionally, in some embodiments, the system can apply Retrieval-Augmented Generation (RAG) techniques to further enhance the quality and contextual relevance of this supplemental information. Specifically, RAG enables the system (e.g., the GenAI model/service) to query additional knowledge stores (e.g., such as curated cybersecurity knowledge bases, trusted internal databases, or authoritative external repositories) during the analysis process. By retrieving relevant context or corroborating information from these knowledge stores, the GenAI model not only extracts supplemental evidence but also carefully contextualizes such evidence/information. This RAG-based technique ensures that supplemental data remains accurate, contextually precise, and directly relevant to the website classification task.

The iterative interplay between the GenAI-driven extraction and RAG-assisted contextualization significantly strengthens the analytical robustness of the supplemental evidence. The supplemental information collected via this technique can then be directly integrated with previously obtained search results evidence, enhancing both the depth and reliability of the evidence set. Consequently, this enriched evidence set leads to substantially improved accuracy and confidence in the system's subsequent analysis stages, ultimately enabling more precise, contextually aware, and reliable classification of target websites.

Returning to the example shown, at 1405, the system obtains an indication to extract classification evidence based on the search results. At 1410, the system selects a search result. At 1415, the system extracts information from the website. At 1420, the system queries an LLM to extract website evidence based on the information extracted from the website. At 1425, the system obtains supplemental evidence for the website. For example, the system can obtain the supplemental evidence from a third party service or from a knowledge base, etc. At 1430, the system stores classification evidence based on the website evidence and the supplemental evidence. For example, the system stores the website evidence and any/certain supplemental evidence as classification evidence to be used in determining a website classification (e.g., a classification of whether the website/domain is malicious or benign). At 1435, the system determines whether another search result is to be analyzed. In some embodiments, the system processes/analyzes all search results returned from the search engine(s). In some embodiments, the system processes a threshold number or threshold percentage of search results from a search engine(s), for example, the top/highest-ranked search results. In response to determining that another search result is to be analyzed, process 1400 returns to 1410 and process 1400 iterates over 1410-1435 until no further search results are to be analyzed (e.g., no further search results exist, or a threshold number/percentage of search results has been processed, etc.). In response to determining that no further search results are to be analyzed, process 1400 proceeds to 1440 at which the system provides the classification evidence. For example, the system stores the classification evidence and/or provides the classification evidence to a classification service that will classify the website (e.g., determine a website classification) based on the classification evidence. At 1445, the system determines whether process 1400 is complete. In some embodiments, process 1400 is determined to be complete in response to a determination that no further classification evidence is to be obtained, no further search results are to be analyzed, no further search results or classification evidence is to be obtained for a website/domain, no further website/domains are to be analyzed, an administrator indicates that process 1400 is to be paused or stopped, etc. In response to a determination that process 1400 is complete, process 1400 ends. In response to a determination that process 1400 is not complete, process 1400 returns to 1405. In some embodiments, rather than performing 1445, process 1400 ends upon determination that the classification evidence has been extracted from all relevant search results for the website(s)/domain(s) to be analyzed.

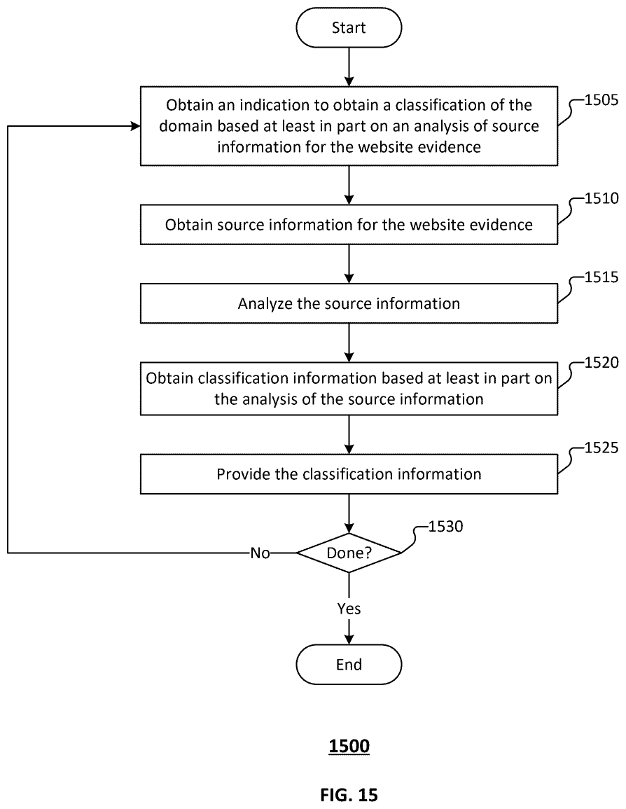

FIG. 15 is a flow diagram of a method for obtaining classification information based on an analysis of source information for classification evidence according to various embodiments. According to various embodiments, process 1500 is implemented at least in part by one or more of system 100 of FIG. 1. In some embodiments, process 1500 is implemented by a network security service, such as security platform 140 of system 100. In some embodiments, process 1500 is implemented at an inline security entity, such as a firewall or a client software running at a client system, such as in a security service enforced for a web browser running at the client system. Process 1500 can be implemented in connection with process 200 FIG. 2, process 300 of FIG. 3, and/or process 1100 of FIG. 11. In some embodiments, process 1500 is invoked by process 1100, such as at 1115. In some embodiments, process 1500 is invoked by process 1700, such as at 1710.

According to various embodiments, in response to collecting search results and extracting relevant evidence from the search results, the system analyzes the sources of this evidence, focusing specifically on the websites corresponding to the search results. For example, the system analyzes source information for the various sources associated with the search results. In some embodiments, this analysis is performed by a dedicated component/service known as the source analyzer. The source analyzer systematically assesses each evidence source's credibility, reliability, reputation, and overall trustworthiness, as these characteristics significantly influence how much weight the system should attribute to the extracted evidence during the website classification process.

In some embodiments, the system leverages an LLM to perform source categorization as part of this analysis. Specifically, the LLM examines contextual clues, metadata, textual content, and structural characteristics of each source website (e.g., or other source in the case of supplemental information) to categorize the source from which classification evidence is extracted according to predefined categories such as professional social networking platforms, media outlets, cybersecurity intelligence repositories, business directories, blogs, or social media platforms. This automated, LLM-assisted categorization provides the system with a standardized and contextually informed view of each source, significantly enhancing consistency and accuracy when evaluating evidence credibility.

Additionally or alternatively, the source analyzer may employ rule-based or heuristics-based analysis methods to evaluate evidence sources. In some embodiments, the source analyzer applies predefined heuristic rules and criteria to judge source reliability. For example, heuristic rules can be implemented to assess whether the evidence source appears across multiple independent search results, whether the source is listed within known authoritative databases (such as, for example, Crunchbase, Yelp, or cybersecurity trust lists, etc.), or whether the website employs rigorous moderation and content verification practices. Conversely, heuristic rules might assign lower credibility scores to sources that allow unrestricted public postings or have a history of containing inaccurate or misleading content.

According to various embodiments, the system implements one or more analytical techniques to determine a website classification, such as to determine classification information based on the source information (e.g., the sources of the classification evidence). For example, by integrating the automated sophistication of LLM-assisted categorization with structured, heuristics-based assessments, the system implements a comprehensive and nuanced analysis of evidence sources. This integrated analytical approach can enable the system to precisely quantify and standardize source credibility, ensuring that subsequent classification decisions accurately reflect the underlying reliability and contextual validity of the extracted evidence.

Returning to the example shown, at 1505, the system obtains an indication to obtain a classification domain based at least in part on an analysis of source information for the website evidence. At 1510, the system obtains source information for the website evidence. For example, the system obtains information pertaining to the sources of the corresponding website evidence. In some embodiments, the system analyzes the source information based at least in part on a set of predefined rules or heuristics. In some embodiments, the system analyzes the source information based at least in part on querying a machine learning model to obtain classification information (e.g., information indicative of a website classification, or information indicative of a trustworthiness of a source for the website evidence, etc.), for example, by querying an LLM for a website classification based on the classification evidence or for classification information for the website to be used by another system or service to obtain the website classification.. At 1515, the system analyzes the source information. At 1520, the system obtains classification information based at least in part on the analysis of the source information. At 1525, the system provides the classification information. For example, the system provides the classification information to another system, service, or other process, such as one that invoked process 1500. At 1530, the system determines whether process 1500 is complete. In some embodiments, process 1500 is determined to be complete in response to a determination that no further website classifications are to be performed, the classification information determined based on the source information (e.g., a feature vector, or other representation of the source information based on the analysis) has been stored a used to update systems enforcing security policies (e.g., to update allowlists or denylists), an administrator indicates that process 1500 is to be paused or stopped, etc. In response to a determination that process 1500 is complete, process 1500 ends. In response to a determination that process 1500 is not complete, process 1500 returns to 1505. In some embodiments, rather than performing 1530, process 1500 ends upon determination that the classification information has been determined and provided (e.g., to another system, service, or process, such as one that invoked process 1500).

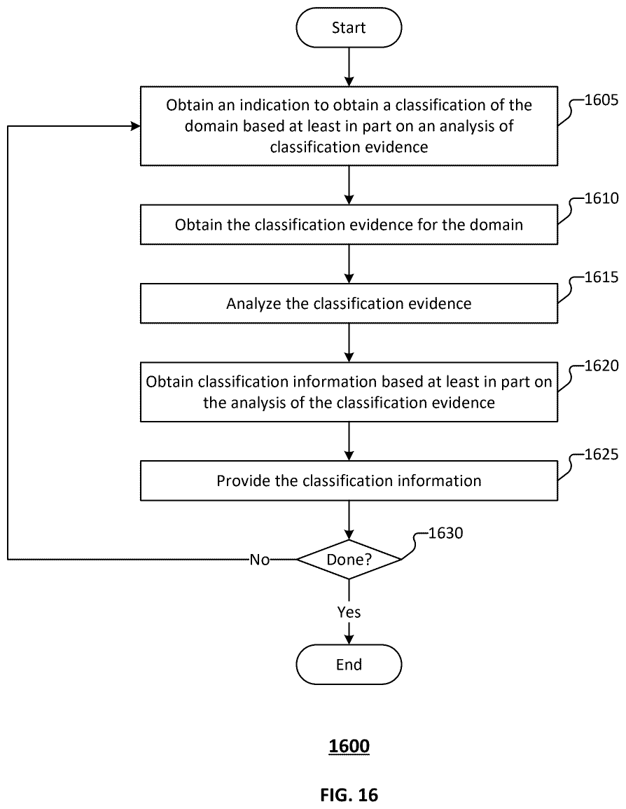

FIG. 16 is a flow diagram of a method for obtaining classification information based on classification evidence obtained based at least in part on the search results for the particular domain according to various embodiments. According to various embodiments, process 1600 is implemented at least in part by one or more of system 100 of FIG. 1. In some embodiments, process 1600 is implemented by a network security service, such as security platform 140 of system 100. In some embodiments, process 1600 is implemented at an inline security entity, such as a firewall or a client software running at a client system, such as in a security service enforced for a web browser running at the client system. Process 1600 can be implemented in connection with process 200 FIG. 2, process 300 of FIG. 3, and/or process 1100 of FIG. 11. In some embodiments, process 1600 is invoked by process 1100, such as at 1120. In some embodiments, process 1600 is invoked by process 1700, such as at 1715.

According to various embodiments, in response to collecting evidence extracted from search results and their corresponding websites, the system conducts an in-depth analysis of this evidence, for example, through a dedicated component known as the evidence analyzer. In some embodiments, the analysis of the classification evidence comprises closely examining the content, context, and detailed characteristics of the evidence, such as URLs, domain names, IP addresses, textual references, metadata, and the manner in which the target website is referenced or utilized across various third-party sites. Similar in approach to a malicious indicator analysis, the evidence analyzer systematically evaluates these details to identify patterns, anomalies, or reputational signals indicative of benign or potentially malicious behavior.

In some embodiments, the evidence analyzer (e.g., the system or service that analyzes the classification evidence such as the evidence extracted from the search results) implements a structured rule-based or heuristics-based approach. Under this model, predefined rules or heuristics are applied to systematically evaluate each piece of extracted evidence. For instance, heuristic rules might flag evidence based on known indicators such as suspicious URL patterns, newly registered domains, usage of known compromised IP addresses, or textual references indicating phishing, fraud, or malware activities. Conversely, evidence consistently associated with trusted entities, legitimate activities, or recognized reputable third-party platforms is assigned higher confidence or trust scores.

In alternative or complementary embodiments, the system may incorporate a specialized machine learning (ML) model specifically trained to analyze the extracted evidence. The ML model may be an LLM. Such an ML model can be trained on labeled datasets comprising diverse evidence examples, including known benign websites, verified malicious websites, and ambiguous or borderline cases. Through this training, the ML model learns to recognize subtle patterns or correlations indicative of legitimate versus malicious website behavior. When deployed operationally, this trained ML model evaluates new evidence automatically, classifying it based on previously learned patterns to accurately identify or predict the likelihood of malicious or benign intent.

Additionally, according to various embodiments, the evidence analyzer can leverage a specialized LLM explicitly trained to interpret and analyze the detailed context and content of the extracted evidence. This specialized LLM employs advanced natural language understanding capabilities, for example, to assess nuanced textual and contextual references, accurately interpreting mentions or descriptions of the target website. By parsing complex semantic signals, the LLM evaluates indicators such as whether references to the target website suggest legitimate business purposes, trustworthy partnerships, community endorsements, or, alternatively, suspicious or misleading usage indicative of malicious intent. The LLM-driven analysis can provide depth and sophistication that traditional heuristic or ML-based methods alone may not fully achieve.

According to various embodiments, the system implements one or more analytical techniques to determine a website classification. For example, by integrating multiple analytical techniques (e.g., heuristic rules, trained ML models, and specialized LLM-driven contextual understanding, etc.) the system achieves a comprehensive and nuanced evaluation of extracted evidence. This multi-layered evidence analysis enables highly accurate assessments of websites, substantially improving the reliability and precision of the system's final classification results, thus reducing false positives and false negatives commonly encountered in conventional cybersecurity classification solutions.

Returning to the example shown, at 1605, the system obtains an indication to obtain a classification of the domain based at least in part on an analysis of classification evidence. At 1610, the system obtains the classification evidence for the domain/website. For example, the system obtains the classification evidence extracted from the search results (e.g., the websites for the search results) and/or from supplemental information obtained from other sources (e.g., a knowledge base, a third party service, etc.). At 1615, the system analyzes the classification evidence. At 1615, the system analyzes the classification evidence. In some embodiments, the system analyzes the classification evidence based at least in part on a set of predefined rules or heuristics. In some embodiments, the system analyzes the classification evidence based at least in part on querying a machine learning model to obtain classification information (e.g., information indicative of a website classification, etc.), for example, by querying an LLM for a website classification based on the classification evidence or for classification information for the website to be used by another system or service to obtain the website classification. At 1620, the system obtains classification information based at least in part on the analysis of the classification evidence. In some embodiments, the classification information may comprise a feature vector representing the analyzed classification evidence. At 1625, the system provides the classification information. For example, the system provides the classification information to another system, service, or other process, such as one that invoked process 1600. At 1630, the system determines whether process 1600 is complete. In some embodiments, process 1600 is determined to be complete in response to a determination that no further website classifications are to be performed, the classification information determined based on the classification evidence (e.g., a feature vector, or other representation of the classification evidence based on the analysis) has been stored and/or used to update systems enforcing security policies (e.g., to update allowlists or denylists), an administrator indicates that process 1600 is to be paused or stopped, etc. In response to a determination that process 1600 is complete, process 1600 ends. In response to a determination that process 1600 is not complete, process 1600 returns to 1605. In some embodiments, rather than performing 1630, process 1600 ends upon determination that the classification information has been determined and provided (e.g., to another system, service, or process, such as one that invoked process 1600).

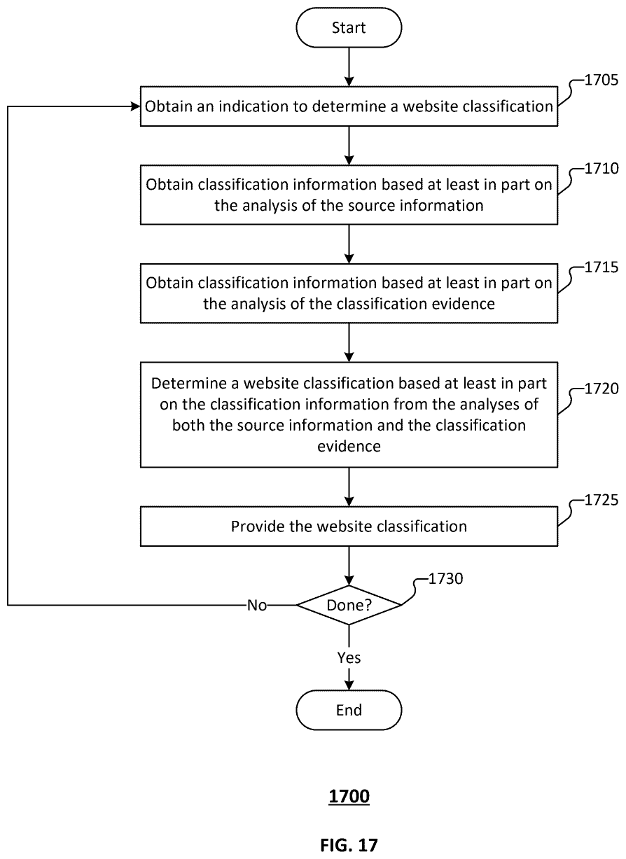

FIG. 17 is a flow diagram of a method for obtaining a website classification for a domain according to various embodiments. According to various embodiments, process 1700 is implemented at least in part by one or more of system 100 of FIG. 1. In some embodiments, process 1700 is implemented by a network security service, such as security platform 140 of system 100. In some embodiments, process 1700 is implemented at an inline security entity, such as a firewall or a client software running at a client system, such as in a security service enforced for a web browser running at the client system. Process 1700 can be implemented in connection with process 200 FIG. 2, process 300 of FIG. 3, and/or process 1100 of FIG. 11. In some embodiments, process 1700 is invoked by process 1100, such as at 1120.

According to various embodiments, in response to completion of the independent analyses performed by the evidence analyzer and the source analyzer, the system integrates these analytical outcomes (e.g., synthesizes classification information) to generate a comprehensive assessment of the target website. This integration combines the nuanced evaluations of content, context, and domain characteristics derived from the evidence analyzer with credibility and reputational assessments produced by the source analyzer. By synthesizing these separate yet complementary insights, the system can achieve a more complete and balanced understanding, ensuring that classifications account for both the reliability of information sources and the specific details of the extracted evidence itself.

In some embodiments, the integration step is performed using an advanced LLM, which serves as a sophisticated analytical engine capable of synthesizing the complex, multi-dimensional outputs from the evidence and source analyzers. Specifically, the LLM receives structured summaries or detailed assessments (e.g., classification information) from both analyzers, encompassing information such as source credibility ratings, reputational indicators, extracted URL or domain patterns, textual references, contextual usage details, and known indicators of maliciousness or legitimacy, etc. The LLM then interprets and combines these varied inputs, evaluating their interrelationships and relative weights to produce an informed and contextually-aware website classification.

The LLM used in this integrative step can be specifically trained or fine-tuned to perform such classification tasks, effectively leveraging learned patterns and contextual understanding to recognize subtle relationships or contradictions among the collected data points. In some embodiments, this classification-focused LLM may be the same as the model previously employed for extracting evidence and analyzing sources, thus providing continuity and preserving contextual consistency across the analytical pipeline. Alternatively, a separate, specifically trained LLM might be utilized for this synthesis task, tailored/trained explicitly to handle complex decision-making and the integration of diverse analytical outputs.

The resulting integrated assessment, produced by the LLM, generates a final classification decision (e.g., a website classification) indicating whether the target website should be considered benign, malicious, or potentially ambiguous. This classification decision is made with enhanced accuracy and nuance compared to conventional techniques, for example, because this system/technique can simultaneously account for the reliability of sources and the detailed content-based evidence collected during the analysis phase. By employing an LLM to intelligently synthesize multiple layers of analytical insights, the system significantly reduces classification errors, such as false positives or negatives, commonly associated with simpler heuristic or static approaches.

Returning to the example shown, at 1705, the system obtains an indication to determine a website classification. At 1710, the system obtains classification information based at least in part on the analysis of the source information. At 1715, the system obtains classification information based at least in part on the analysis of the classification evidence. At 1720, the system determines a website classification based at least in part on the classification information from the analyses of both the source information and the classification evidence. For example, the system synthesizes the classifications of, or results from respectively analyzing, the classification evidence and corresponding source information. At 1725, the system provides the website classification. For example, the system provides the website classification to another system, service, or other process, such as one that invoked process 1700. At 1730, the system determines whether process 1700 is complete. In some embodiments, process 1700 is determined to be complete in response to a determination that no further website classifications are to be performed, the website classification has been stored and/or used to update systems enforcing security policies (e.g., to update allowlists or denylists), an administrator indicates that process 1700 is to be paused or stopped, etc. In response to a determination that process 1700 is complete, process 1700 ends. In response to a determination that process 1700 is not complete, process 1700 returns to 1705. In some embodiments, rather than performing 1730, process 1700 ends upon determination and provision of the website classification.

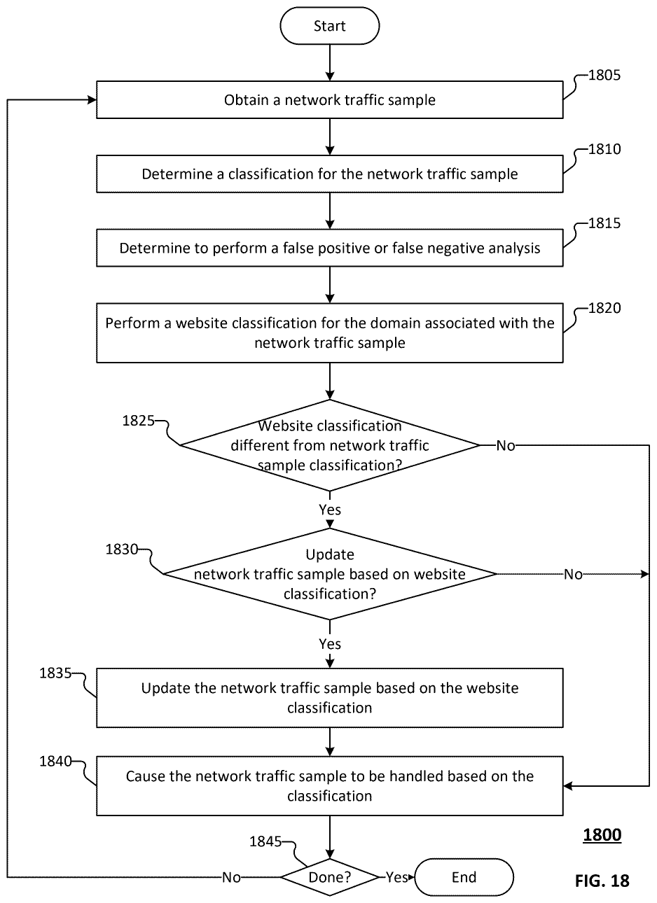

FIG. 18 is a flow diagram of a method for using the website classification in connection with detecting an erroneous network traffic sample classification according to various embodiments. According to various embodiments, process 1800 is implemented at least in part by one or more of system 100 of FIG. 1. In some embodiments, process 1800 is implemented by a network security service, such as security platform 140 of system 100. In some embodiments, process 1800 is implemented at an inline security entity, such as a firewall or a client software running at a client system, such as in a security service enforced for a web browser running at the client system. Process 1800 can be implemented in connection with process 200 FIG. 2, process 300 of FIG. 3, and/or process 1100 of FIG. 11.

In some embodiments, in response to determining (e.g., predicting) the website classification by integrating outputs from the evidence source analyzer (e.g., the analysis of the source information for the websites of search results) and the extracted evidence analyzer (e.g., the analysis of the websites/resources comprised in the search results), the system subsequently provides or makes accessible this website classification, for example, in various formats tailored to specific operational scenarios or downstream use cases. One primary approach includes storing the classification result within a dedicated classification database. This database (e.g., website classification trusted database) can act as a trusted reference, making classifications readily accessible for future inquiries or analyses. The classification database thus serves as an authoritative knowledge repository, allowing other security components or services within an organization's cybersecurity infrastructure to efficiently query and retrieve website classifications for decision-making or ongoing threat monitoring.

In some embodiments, once stored in the classification database, these results (e.g., the website classifications) can serve multiple downstream processes, enabling services such as automated website categorization, risk assessment workflows, or periodic reevaluation of domains previously flagged by traditional maliciousness detectors. By maintaining a centralized and continuously updated record of website classifications, the system helps ensure consistency and accuracy in network security policies and enforcement actions.

Additionally, or alternatively, the system can directly interface with real-time detection or threat prevention services. In scenarios where inline maliciousness detectors (e.g., such as network traffic monitors, secure gateways, or intrusion detection systems, etc.) initially flag websites as malicious or suspicious, the system can provide immediate reclassification outputs to dynamically correct or confirm such classifications. This real-time capability is particularly valuable for rapidly detecting and/or rectifying false positives or false negatives. For example, when an inline detection service intercepts network communications (e.g., a network traffic sample) and flags a legitimate website incorrectly as malicious, the system's classification can promptly recharacterize the website as benign, thereby preventing unnecessary disruption to legitimate user activity.

Furthermore, by offering immediate, accurate classification feedback directly to inline detectors, the system enhances operational efficiency and reduces operational overhead. This responsiveness ensures that organizations can swiftly and reliably distinguish between genuine threats and harmless websites, optimizing resource allocation and strengthening overall cybersecurity defenses. Ultimately, whether through direct integration with real-time detection systems or via updates to a trusted classification database and/or applicable allowlists or denylists, the system's output facilitates improved decision-making and precision in website-related cybersecurity operations.

Returning to the example shown, at 1805, the system obtains a network traffic sample. At 1810, the system determines a classification for the network traffic sample. For example, the system queries a classifier (e.g., comprising one or more of a machine learning model(s) or rule/heuristics-based classifier(s)) for a predicted classification for a network traffic sample (e.g., an indication of whether the network traffic sample is malicious or benign). The network traffic sample may be a sample intercepted by an inline security entity (e.g., a firewall such as a next generation firewall) and classified locally/inline at the inline security entity and/or provided to a cloud service for a real time or offline classification. At 1815, the system determines to perform a false positive or false negative analysis. In response to determining that a false positive or false negative analysis is to be performed, at 1820, the system performs a website classification for the domain associated with the network traffic sample, for example, by querying ga service that implements process 1100, process 1700, etc. At 1825, the system determines whether the website classification is different from the network traffic sample classification. In response to determining that the website classification is not different from the network traffic sample classification (e.g., in response to validating the network traffic sample classification), process 1800 proceeds to 1840. Conversely, in response to determining that the website classification is different from the network traffic sample, process 1800 proceeds to 1830 at which the system determines whether to update the network traffic sample classification based on the website classification. For example, the system determines whether the network traffic sample classification is a false positive or false negative, or whether the system is to continue to deem the classification to be the network traffic sample classification. In response to determining that the network traffic sample classification is not to be updated based on the website classification, process 1800 proceeds to 1840. Conversely, in response to determining that the network traffic sample classification is to be updated based on the website classification, process 1800 proceeds to 1835 at which the system updates the network traffic sample classification based on the website classification. For example, the system sets the network traffic sample classification to be equal to the website classification, or the system otherwise uses the website classification as the classification for the domain/website. At 1840, the system causes the network traffic sample to be handled based on the classification. For example, the system causes one or more security policies to be enforced with respect to network traffic for the domain/website based on the classification. The system can provide a real time indication of the classification to an inline security entity (e.g., a firewall, a client software running on a client system, etc.), and the inline security entity can enforce the applicable security policy(ies). The system may additionally or alternatively update an allowlist or denylist based on the classification and push the updates to the allowlist or denylist to inline security entities for use in local security policy enforcement. At 1845, the system determines whether process 1800 is complete. In some embodiments, process 1800 is determined to be complete in response to a determination that no further network traffic samples are to be handled, the allowlist or denylist has been updated and provided to security entities, an administrator indicates that process 1800 is to be paused or stopped, etc. In response to a determination that process 1800 is complete, process 1800 ends. In response to a determination that process 1800 is not complete, process 1800 returns to 1805. In some embodiments, rather than performing 1845, process 1800 ends upon determination that the security policy has been enforced or that the network traffic sample has been handled.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
obtain an indication of a website to be classified;
obtain search results for the website;
obtain classification evidence for the website and search results based at least in part on querying a first large language model (LLM) for the classification evidence; and
provide a website classification based at least in part on classification evidence; and
a memory coupled to the one or more processors and configured to provide the one or more processors with instructions.

2. The system of claim 1, wherein the search results for the website are collected based at least in part on querying one or more search engines based at least in part on the website.

3. The system of claim 1, wherein the website to be classified corresponds to a domain for which a maliciousness detector classified as malicious.

4. The system of claim 1, wherein providing the website classification comprises storing the website classification in a classifications database.

5. The system of claim 1, wherein the website classification is obtained based at least in part on querying a second LLM based on the classification evidence.

6. The system of claim 5, wherein the second LLM determines a website category for the website to be classification.

7. The system of claim 5, wherein the second LLM is different from the first LLM.

8. The system of claim 5, wherein obtaining the website classification comprises:
obtaining website intelligence knowledge from one or more knowledge sources; and
querying the second LLM for a website classification based at least in part on the classification evidence and the website intelligence knowledge.

9. The system of claim 8, wherein the website intelligence knowledge is obtained based at least in part on performing a Retrieval-Augmented Generation (RAG) search of a predefined knowledge base.

10. The system of claim 8, wherein the website intelligence knowledge comprises URL filtering category changes over time.

11. The system of claim 8, wherein obtaining website intelligence knowledge from one or more knowledge sources comprises querying a DNS security knowledge base to obtain information pertaining to one or more of a behavior, a usage, and a classification for the website.

12. The system of claim 1, wherein the classification evidence comprises a set of information for evidence sources and a set of information for evidence.

13. The system of claim 12, wherein the website classification is obtained based at least in part on (i) an analysis of the set of information for evidence sources, and (ii) an analysis of a set of information for evidence.

14. The system of claim 13, wherein obtaining the website classification comprises querying a second LLM to determine the website classification based on (i) results from the analysis of the set of information for evidence sources, and (ii) results from analysis of a set of information for evidence.

15. The system of claim 13, wherein the analysis of the set of information for evidence sources comprises determining a trustworthiness or a reputation of a source for a particular search result.

16. The system of claim 1, wherein providing the website classification comprises providing an indication of whether a previous classification for the website is a false positive maliciousness detection.

17. The system of claim 1, wherein the indication of the website to be classified is receive in response to a maliciousness classification service classifying the website as malicious.

18. A method, comprising:
obtaining an indication of a website to be classified;
obtaining search results for the website;
obtaining classification evidence for the website and search results based at least in part on querying a large language model (LLM) for the classification evidence; and
providing a website classification based at least in part on classification evidence.

19. A computer program product embodied in a non-transitory computer readable medium and comprising computer instructions for:
obtaining an indication of a website to be classified;
obtaining search results for the website;
obtaining classification evidence for the website and search results based at least in part on querying a large language model (LLM) for the classification evidence; and
providing a website classification based at least in part on classification evidence.

20. A system, comprising:
one or more processors configured to:
obtain a set of search engine results associated with a set of false positive classification samples;
collect additional domain knowledge for the set of false positive classification samples;
analyze the set of search engine results and the additional domain knowledge to determine classification indicators, including querying a large language model (LLM) for classification evidence; and
store the classification evidence, wherein the classification is used to perform website classification for a set of target websites; and
a memory coupled to the one or more processors and configured to provide the one or more processors with instructions.

21. The system of claim 20, wherein the one or more processors are further configured to:
obtain an indication of the set of target website; and
in response to receiving the indication of the set of target websites, perform an automated analysis of search results and source content for the set of target websites in connection with categorizing the set of target domains and determining website classifications.
